(19) United States
(12) Patent Application Publication
(10) Pub. No.: US 2006/0218078 A1
(43) Pub. Date: Sep. 28, 2006

(54) Method and apparatus for renting, customizing, and delivering risk and/or volatility products

(76) Inventor: Freeman A. Jackson, Newark, NJ (US)

Correspondence Address: Freeman A. Jackson, Suite 13, 219 Mount Prospect Ave., Newark, NJ, 07104, US

(21) Appl. No.: 11/091,657

(22) Filed: Mar. 28, 2005

(51) Int. Cl. G06Q 40/00

(52) U.S. Cl. 705/38

(57) ABSTRACT

According to a computer-implemented approach for renting, customizing, manufacturing, intermediating, and delivering risk and volatility product to customers, customers specify what risk or volatility product to rent using a plurality of risk and/or product selection parameters. According to the approach, customers provide a plurality of risk and/or volatility product selection parameters to a provider provides the risk and volatility product indicated by the plurality of risk and/or volatility product selection parameters to customer over a delivery channel. The risk and/or volatility product provider may be either centralized or distributed depending upon the requirements of a particular application.

Method and apparatus for renting, customizing, manufacturing intermediating, and delivering risk and/or volatility products.

### RELATED APPLICATIONS

U.S. Patent Documents

| | | |
|---|---|---|
| 6,842,604 | January 2005 | Cook, et al. |
| 6,405,245 | June 2002 | Burson, et al. |
| 6,606,596 | August 2003 | Zirngibl, et al. |
| 6,850,603 | February 2005 | Eberle, et al. |
| 5,918,213 | June 1999 | Bernard, et al. |
| 5,664,110 | September 1997 | Green, et al. |
| 6,594,642 | July 2003 | Lemchen |
| 6,584,450 | June 2003 | Hastings |
| 6,839,686 | August 2003 | Galant, et al. |
| 6,772,146 | August 2003 | Khemlani, et al. |
| 6,349,290 | February 2002 | Hastings |
| 6,681,211 | January 2004 | Gatto, et al. |
| 6,211,880 | April 1998 | Impink, Jr. |
| 6,195,103 | November 1997 | Stewart |
| 5,918,217 | November 1997 | Stewart |
| 6,801,201 | December 2002 | Escher |
| 6,298,334 | October 2001 | Burfield, et al. |
| 6,453,303 | September 2002 | Li |
| 6,546,375 | April 2003 | Pang, et al. |
| 6,862,579 | August 2003 | Mathews, et al. |
| 6,772,136 | August 2004 | Kant, et al. |
| 6,061,662 | May 2000 | Makivic |
| 6,829,590 | December 2004 | Greener, et al. |
| 5,991,743 | November 1999 | Irving, et al. |
| 5,696,907 | December 1997 | Tom |
| 6,119,103 | September 2000 | Basch, et al., |
| 5,732,397 | March 1998 | DeTore, et al. |
| 6,708,155 | March 2004 | Honarvar, et al. |
| 6,611,807 | August 2003) | Bernheim, et al. |
| 5,991,744 | November 1999 | DiCresce |
| 6,292,787 | September 2001 | Scott, et al. |
| 6,484,152 | August 2001 | Robinson |
| 5,361,201 | November 1994 | Jost, et al. |
| 6,058,369 | May 2000 | Rothstein |
| 6,235,176 | May 2001 | Schoen, et al. |
| 6,275,807 | August 2001 | Schirripa |
| 6,611,815 | August 2003 | Lewis, et al. |
| 6,029,149 | February 2000 | Dykstra, et al. |
| 5,262,941 | November 1993 | Saladin, et al. |
| 6,385,594 | May 2002 | Lebda, et al. |
| 6,850,643 | February 2005 | Smith, II, et al |
| 6,018,721 | January 2000 | Aziz, et al. |
| 6,195,647 | February 2001 | Martyn, et al. |
| 4,376,978 | March 1983 | Musmanno, et al. |
| 5,913,202 | June 1999 | Motoyama |

Foreign Patent Documents
Other Documents
Bates, David S. (1996). Jumps and stochastic volatility: exchange rate processes implicit in deutsche mark options, Review of Financial Studies, 9 (1) 69-107.
Black, Fischer (1976). The pricing of commodity contracts, Journal of Financial Economics, 3, 167-179.
Black, Fischer and Myron S. Scholes (1973). The pricing of options and corporate liabilities, Journal of Political Economy, 81, 637-654.
Britten-Jones, M. and A. Neuberger (2000). Option prices, implied prices processes, and stochastic volatility, Journal of Finance, 55 (2), 839-866.
Derman, Emanuel (1999). Regimes of volatility, Risk, 4, 55-59. Available in Lipton (2003).
Dupire, Bruno (1996). A unified theory of volatility, working paper.
Heston, Steven L. (1993). “A closed-form solution for options with stochastic volatility with applications to bond and currency options,” Review of Financial Studies, 6 (2), 327-43.
Hull, John C. and Allen White (1988). “An analysis of the bias in option pricing caused by a stochastic volatility,” Advances in Futures and Options Research, 3, 29-61.
Merton, R. (1976). Option pricing when underlying stock returns are discontinuous, Journal of Financial Economics, 3, 125-144. Available in Merton (1992).
Manfredo, Mark Ronald (1994). “Volatility forecasting and value-at-risk: an application to cattle feeding, “American Journal of Agricultural Economics, August 2000, vol. 82, no. 3, pp. 785-791(3).
Michael Y. Hu, Christine X. Jiang and Christos Tsoukalas. “The volatility impact of the European monetary system on member and non-member currencies,” Applied Financial Economics, 2004, vol. 14, issue 5, pages 313-325
Litterman R., Scheinkman J. & Weiss L. (1991) “Volatility and the yield curve”, Journal of Fixed Income, Vol. 1, No. 1, June, pp. 49-53.
Julia Litvinova. (2004) “Volatility asymmetry in high-frequency data”, downloaded from Website http://www.missouri.edu/˜econwww/MEG_Papers/Julia %20Litvinova.pd f, in Mar. of 205.
Stulz, René, 1996, “Rethinking Risk Management,” Journal of Applied Corporate Finance, Vol. 9, No. 3 (Fall), pp. 8-24.
Cumming, Christine, and Beverly Hirtle, 2001, “The Challenges of Risk Management in Diversified Financial Companies,” FRBNY Economic Policy Review (March), pp. 1-17.
Andersen, Torben, Tim Bollerslev, Francis X. Diebold, and Peter Christoffersen, 2004, “Practical volatility and correlation modeling for financial market risk management,” in Mark Carey and Rene M. Stulz, The risks of financial firms, forthcoming.
Artzner, Philippe, Freddy Delbaen, Jean-Marc Eber, and David Heath, 1999, “Coherent measures of risk,” Mathematical Finance 9, 208-223.
Danielsson, Jon, and Casper de Vries, 1997, “Value-at-Risk and Extreme Returns,” Discussion Paper No. 273, pp. 1-33 (London: School of Economics and Political Science).
Ju, Xiongwei, and Neil Pearson, 1998, “Using value-at-risk to control risk taking: how wrong can you be?,” The Journal of Risk 1, 5-36.
Duffie, Darrell, and Jun Pan, 1997, “An overview of value at risk,” The Journal of Derivatives, Vol. 4, No. 3 (Spring) pp. 7-49.
Litterman, Robert, 1996, “Hot Spot and Hedges,” Journal of Portfolio Management, Special Issues, 52-75.
Committee on the Global Financial System, Basel, 2001, “A Survey of Stress Tests and Current Practice at Major Financial Institutions,” (Switzerland: Bank for International Settlements).
Hull, John, and Alan White, 1998, “Value at Risk When Daily Changes in Market Variables are Not Normally Distributed,” The Journal of Derivatives, Vol 5, No 3 (Spring) pp. 9-19.
Berkowitz, Jeremy and James O'Brien, “How Accurate are Value-at-Risk Models at Commercial Banks?”, Journal of Finance 57, No 3, 1093-1111.
Jorion, Philippe, “Risk Management Lessons From Long-Term Capital Management,” European financial Management, Vol. 6, No.3, 2000, 277-300.
J. R. Aragones, C. Blanco, and K. Dowd, 2001, “Incorporating Stress Tests into Market Risk Modeling,” Derivatives Quarterly, Spring, 44-49.
Kiesel, Rudiger, William Perraudin, and Alex Taylor, 2000, “An extremes analysis of VaRs for emerging market benchmark bonds,” working paper, Birkbeck College, London, England.
Bams, Dennis, Thorsten Lehnert, and Christian C. Wolff, 2003, “An evaluation framework for Alternative VaR models,” working paper, Masstricht University.
Anil Bangia, Francis X. Diebold, Til Schurmann, and John Stroughair, 1999, Modeling liquidity risk, with implications for traditional market risk measurement and management, Financial Institutions Center, The Wharton School, University of Pennsylvania.
Embrechts, Paul, 2000, “Extreme value theory: Potential and limitations as an integrated risk management tool,” working paper, ETH Zurich.
Grammig, Joachim and Pierre Giot, 2002, “How Large is Liquidity Risk in an Automated Auction Market?” Discussion paper 2002-23, University of St. Gallen, Swiss Institute of Banking and Finance.
Sadorsky, Perry, 2005, “Stochastic volatility forecasting and risk management” Applied Financial Economics, 2005, 15, 121-135
Ju, Xiongwei and Pearson, Neil, 1998, “Using value-at-risk to control risk taking: how wrong can you be?” Journal of Risk Volume 1/Number 2, Winter 1998/1999
Nain, Amrita, “The Strategic Motives for Corporate Risk Management” http://www-personal.umich.edu/˜anain/Research_files/NAIN_SEPT16.pdf
Gibson, Michael S., 1998, “The Implications of Risk Management Information Systems for the Organization of Financial Firms,” International Finance Discussion Papers No. 632 (Washington: Board of Governors of the Federal Reserve System).
Fehle, Frank and Tsyplako, Sergey, “Dynamic Risk Management: Theory and Evidence” http://dmsweb.moore.sc.edu/tsyplakov/papers/Fehle_Tsyplakov.pdf

Geczy, Christopher, Bernadette Minton, and Catherine Schrand, “Why Firms Use Currency Derivatives,” Journal of Finance, September 1997, 1323-1348. http://fisher.osu.edu/˜fin/journal/archive_papers/isssept97/ms48 06.pdf
Artzner, Philippe, Freddy Delbaen, Jean-Marc Eber, and David Heath, 1999, “Coherent measures of risk,” Mathematical Finance 9, 208-223. www.math.ethz.ch/˜delbaen/ftp/preprints/CoherentMF.pdf
Duffie, Darrell, and Jun Pan, 1997, “An overview of value at risk,” The Journal of Derivatives, Vol. 4, No. 3 (Spring) pp. 7-49.
*Berkowitz, Jeremy and James O'Brien, “How Accurate are Value-at-Risk Models at Commercial Banks?”, Journal of Finance 57, No 3, 1093-1111.
Estimating Value at Risks for Short and Long Trading Positions http://www.eco.fundp.ac.be/cerefim/varpaper/200200. %20(Sriananth akumar %20 and %20Silvapulle)-Estimating %20VaR %20for %20Long %20 and %20Short %20Trading %20Position s.pdf
Granger, C. and S.-H. Poon (2002), Forecasting Volatility in Financial Markets: A Review, September.
Allayannis, George, and James P. Weston, “The Use of Foreign Currency Derivatives and Firm Market Value,” The Review of Financial Studies, Spring 2001, 243-276. http://faculty.darden.virginia.edu/allayannisy/ATT148761.pdf
“subscribe to risk” exact phrase search using the following Google URL: http://www.google.com/search?q=+%22subscribe+to+risk %22&num=100& hl=en&lr=&as_qdr=all&start=100&sa=N
Security Futures OCC Operational Overview http://www.optionsclearing.com/initiatives/security_futures/secu rity_futures_overview.jsp
Lexis Nexis® Risk Management Solutions http://www.lexisnexis.com/risksolutions/management/Default. asp
EGAR Technology, Inc. http://www.egartech.com/company_sum.asp
About Us
http://www.riskdataflow.com

### BACKGROUND OF THE INVENTION

1. Field of the Invention

The invention relates generally to processes for customizing, renting, purchasing, manufacturing, and intermediating risk and/or volatility products in particular but not limited (i.e. the invention also relates to gene sequencing and weather) to the following areas:

a. Customizable Electronic Works,

b. Remote Renting and/or Purchasing,

c. Automated Manufacturing and Ordering over the Internet,

d. Accessing Investment Information and Analysis,

e. Displaying Investment Information and Analysis,

f. Automated Analysis for Financial Assets,

g. Automated Volatility Analysis for Financial Assets,

h. Risk Management Systems,

i. Strategic and Financial Planning Systems,

j. Real Estate Systems,

j. Insurance/Retirement Systems, and

k. Credit Systems.

l. Misc.

m. Advantages of the present invention

2. Description of Related Art

a. Customizable Electronic Works

Customizing electronic works, is well known to the art. For example, by Cook, et al., “Personal digital content system,” U.S. Pat. No. 6,842,604 (Jan. 11, 2005), Burson, et al., “System and method for automated access to personal information,” U.S. Pat. No. 6,405,245 (Jun. 11, 2002), Zirngibl, et al., Zirngibl, et al., “System and method for the creation and automatic deployment of personalized, dynamic and interactive voice services, including deployment through digital sound files,” U.S. Pat. No. 6,606,596 (Aug. 12, 2003), and Eberle, et al., “System and method for the creation and automatic deployment of personalized dynamic and interactive voice services,” U.S. Pat. No. 6,850,603 (Feb. 1, 2005), each of which is herein incorporated by reference in its entirety, related to customizable electronic works. None of these references, however, provides for provide for electronic work customization, automatic electronic work manufacturing, and the data administration of the present invention. This prior art does not provide for risk and/or volatility product customization, automatic risk and/or volatility product manufacturing, risk and/or volatility product purchasing and/or rental, risk and/or volatility product intermediating, risk and/or volatility product display and data administration/integration of the present invention.

b. Remote Renting and/or Purchasing

Remote Renting and/or Purchasing, is well known to the art. For example, Bernard, et al., “System and method for automated remote previewing and purchasing of music, video, software, and other multimedia electronic works,” U.S. Pat. No. 5,918,213 (Jun. 29, 1999), Hastings, “Method and apparatus for renting items,” U.S. Pat. No. 6,584,450 (Jun. 24, 2003), Green, et al., “Remote ordering system,” U.S. Pat. No. 5,664,110 (Sep. 2, 1997), each of which is herein incorporated by reference in its entirety, related to automated remote and/or purchasing. None of these references, however, provides for risk and/or volatility product customization, automatic risk and/or volatility product manufacturing, risk and/or volatility product purchasing and/or rental, risk and/or volatility product intermediating, risk and/or volatility product display and data administration/integration of the present invention.

c. Automated Manufacturing and Ordering over the Internet

Providing an automated process and a system for ordering and manufacturing personalized electronic works over the Internet, is well known to the art, such as the one described by Lemchen, “Automated customized remote ordering and manufacturing process,” U.S. Pat. No. 6,594,642 (Jul. 15, 2003) incorporated herein by reference. This prior work does not provide for risk and/or volatility product customization, automatic risk and/or volatility product manufacturing, risk and/or volatility product purchasing and/or rental, risk and/or volatility product intermediating, risk and/or volatility product display and data administration/integration of the present invention.

d. Accessing Investment Information and Analysis

Several patents have been issued in accessing investment information and analysis. For example, by Galant, et al., “Method and system for providing financial information and evaluating securities of a financial debt instrument,” U.S. Pat. No. 6,839,686 (Aug. 19, 2003), and Hastings, “Automated system and method for customized and personalized presentation of products and services of a financial institution,” U.S. Pat. No. 6,349,290 (Feb. 19, 2002) each of which is herein incorporated by reference in its entirety, related to accessing investment information and analysis. None of these references, however, provides for risk and/or volatility product customization, automatic risk and/or volatility product manufacturing, risk and/or volatility product purchasing and/or rental, risk and/or volatility product intermediating, risk and/or volatility product display and data administration/integration of the present invention.

e. Displaying Investment Information and Analysis

Several patents have been issued in displaying investment information and analysis. For example, by Gatto, et al., “Security analyst estimates performance viewing system and method,” U.S. Pat. No. 6,681,211 (Jan. 20, 2004), Impink, Jr., “Display apparatus,” U.S. Pat. No. 6,211,880 (Apr. 13, 1998), Stewart, “Volatility plot and volatility alert for display of time series data,” U.S. Pat. No. 6,195,103 (Nov. 18, 1997), Stewart, “User interface for a financial advisory system,” U.S. Pat. No. 5,918,217 (Nov. 18, 1997), and Escher, “Method for chart markup and annotation in technical analysis,” U.S. Pat. No. 6,801,201 (Dec. 17, 2002), each of which is herein incorporated by reference in its entirety, related to displaying investment information and analysis. None of these references, however, provides for risk and/or volatility product customization, automatic risk and/or volatility product manufacturing, risk and/or volatility product purchasing and/or rental, risk and/or volatility product intermediating, risk and/or volatility product display and data administration/integration of the present invention.

f. Automated Analysis for Financial Assets

Several patents have been issued in automated analysis for financial assets. For example, by Burfield, et al., “Object-based numeric-analysis engine,” U.S. Pat. No. 6,298,334 (Oct. 2, 2001) and Li, “Automated analysis for financial assets,” U.S. Pat. No. 6,453,303 (Sep. 17, 2002), each of which is herein incorporated by reference in its entirety, related to automated analysis for financial assets. None of these references, however, provides for risk and/or volatility product customization, automatic risk and/or volatility product manufacturing, risk and/or volatility product purchasing and/or rental, risk and/or volatility product intermediating, risk and/or volatility product display and data administration/integration of the present invention.

g. Automated Volatility Analysis for Financial Assets

Several patents have been issued in automated volatility analysis for financial assets. For example, Pang, et al., “Apparatus and method of pricing financial derivatives,” U.S. Pat. No. 6,546,375 (Apr. 8, 2003), Mathews, et al., “Systems, methods and computer program products for performing a generalized contingent claim valuation,” U.S. Pat. No. 6,862,579 (Aug. 19, 2003), Bekaert, et al., Kant, et al., “System and method for financial instrument modeling and using Monte Carlo simulation,” U.S. Pat. No. 6,772,136 (Aug. 3, 2004), and Makivic, “Simulation method and system for the valuation of derivative financial instruments,” U.S. Pat. No. 6,061,662 (May 9, 2000), each of which is herein incorporated by reference in its entirety, related to automated volatility analysis for financial assets. None of these references, however, provides for risk and/or volatility product customization, automatic risk and/or volatility product manufacturing, risk and/or volatility product purchasing and/or rental, risk and/or volatility product intermediating, risk and/or volatility product display and data administration/integration of the present invention.

h. Risk Management Systems

Several patents have been issued in risk management systems. For example, Greener, et al., “Enhanced online sales risk management system,” U.S. Pat. No. 6,829,590 (Dec. 7, 2004), Irving, et al., “System and method for proactively monitoring risk exposure,” U.S. Pat. No. 5,991,743 (Nov. 23, 1999), Tom, “System and method for performing risk and credit analysis of financial service applications,” U.S. Pat. No. 5,696,907 (Dec. 9, 1997), Basch, et al., “Financial risk prediction systems and methods therefor,” U.S. Pat. No. 6,119,103 (Sep. 12, 2000), Smith, II, et al., “Methods and apparatus for collateral risk monitoring,” U.S. Pat. No. 6,850,643 (Feb. 1, 2005), each of which is herein incorporated by reference in its entirety, related to risk management systems. None of these references, however, provides for risk and/or volatility product customization, automatic risk and/or volatility product manufacturing, risk and/or volatility product purchasing and/or rental, risk and/or volatility product intermediating, risk and/or volatility product display and data administration/integration of the present invention.

h. Strategic Planning, Financial Planning, and/or Portfolio Systems

Several patents have been issued in strategic planning, financial planning, and/or portfolio systems. For example, DeTore, et al., “Automated decision-making arrangement,” U.S. Pat. No. 5,732,397 (Mar. 24, 1998), Honarvar, et al., “Decision management system with automated strategy optimization,” U.S. Pat. No. 6,708,155 (Mar. 16, 2004), Bernheim, et al., “Economic security planning method and system,” U.S. Pat. No. 6,611,807 (Aug. 26, 2003), DiCresce, “Method and apparatus that processes financial data relating to wealth accumulation plans,” U.S. Pat. No. 5,991,744 (Nov. 23, 1999), Scott, et al., “Enhancing utility and diversifying model risk in a portfolio optimization framework,” U.S. Pat. No. 6,292,787 (Sep. 18, 2001), Robinson, “Automated portfolio selection system,” U.S. Pat. No. 6,484,152 (Aug. 28, 2001), each of which is herein incorporated by reference in its entirety related to planning, financial planning, and/or portfolio systems. None of these references, however, provides for risk and/or volatility product customization, automatic risk and/or volatility product manufacturing, risk and/or volatility product purchasing and/or rental, risk and/or volatility product intermediating, risk and/or volatility product display and data administration/integration of the present invention.

i. Real Estate Systems

Several patents have been issued in real estate systems, and/or portfolio systems. For example, Jost, et al., “Real estate appraisal using predictive modeling,” U.S. Pat. No. 5,361,201 (Nov. 1, 1994) and Rothstein, “Real estate appraisal using predictive modeling,” U.S. Pat. No. 6,058,369 (May 2, 2000), each of which is herein incorporated by reference in its entirety, related to real estate systems. None of these references, however, provides for risk and/or volatility product customization, automatic risk and/or volatility product manufacturing, risk and/or volatility product purchasing and/or rental, risk and/or volatility product intermediating, risk and/or volatility product display and data administration/integration of the present invention.

i. Insurance/Retirement Systems

Several patents have been issued in insurance and/or retirement systems. For example, Schoen, et al., “Computer apparatus and method for defined contribution and profit sharing pension and disability plan,” U.S. Pat. No. 6,235,176 (May 22, 2001) Schirripa, “Computer system and methods for management, and control of annuities and distribution of annuity payments,” U.S. Pat. No. 6,275,807 (Aug. 14, 2001) Lewis, et al., “Method and system for providing account values in an annuity with life contingencies,” U.S. Pat. No. 6,611,815 (Aug. 26, 2003), each of which is herein incorporated by reference in its entirety, related to insurance and/or retirement systems. None of these references, however, provides for risk and/or volatility product customization, automatic risk and/or volatility product manufacturing, risk and/or volatility product purchasing and/or rental, risk and/or volatility product intermediating, risk and/or volatility product display and data administration/integration of the present invention.

j. Credit Systems

Several patents have been issued in credit systems. For example, Saladin, et al., “Expert credit recommendation method and system,” U.S. Pat. No. 5,262,941 (Nov. 16, 1993), Lebda, et al., “Method and computer network for co-ordinating a loan over the internet,” U.S. Pat. No. 6,385,594 (May 7, 2002), and Aziz, et al., “Method and system for improved collateral monitoring and control,” U.S. Pat. No. 6,018,721 (Jan. 25, 2000), each of which is herein incorporated by reference in its entirety, related to credit systems. None of these references, however, provides for risk and/or volatility product customization, automatic risk and/or volatility product manufacturing, risk and/or volatility product purchasing and/or rental, risk and/or volatility product intermediating, risk and/or volatility product display and data administration/integration of the present invention.

j. Financial Information Intermediary System

Financial information intermediary system, is well known to the art. For example, by Motoyama, “Financial information intermediary system,” U.S. Pat. No. 5,913,202 (Jun. 15, 1999), which is herein incorporated by reference in its entirety, related to credit systems, related to financial information intermediary system. None of these references, however, provides for risk and/or volatility product customization, automatic risk and/or volatility product manufacturing, risk and/or volatility product purchasing and/or rental, risk and/or volatility product intermediating, risk and/or volatility product display and data administration/integration of the present invention.

Institutional Banking and Existing Online Risk Applications

Several commercial applications have been disclosed. For example, Lexis Nexis Risk Management Solutions has disclosed a one-click access to a comprehensive range of investigation, due diligence, and fraud prevention solutions—all from a single Web page. EGAR's free and/or non-customized products FOCUS, EGAR ONE, EGAR ETS, EGAR Dispersion ASP and IVolatility data services, each of which is herein incorporated by reference in its entirety, related to existing commercial applications. None of these references, however, provides for risk and/or volatility product customization, automatic risk and/or volatility product manufacturing, risk and/or volatility product purchasing and/or rental, risk and/or volatility product intermediating, risk and/or volatility product display and data administration/integration of the present invention. Several institutional applications have been disclosed. For example, Security Futures OCC Operation the Options Clearing Corporation (“OCC”) has disclosed a system modifications for the trading of Single Stock and Narrow Based Index Futures (security futures). Martyn, et al. “On-line transaction processing system for security trading,” U.S. Pat. No. 6,195,647 (Feb. 27, 2001) and Musmanno, et al. “Securities brokerage-cash management system,” U.S. Pat. No. 4,376,978 (Mar. 15, 1983). None of these references, however, provides for risk and/or volatility product customization, automatic risk and/or volatility product manufacturing, risk and/or volatility product purchasing and/or rental, risk and/or volatility product intermediating, risk and/or volatility product display and data administration/integration of the present invention.

m. Advantages of the Present Invention

This invention discloses a method and apparatus for renting, customizing, producing, intermediating, and delivering one or more element selected from a group comprising of as means for measuring, monitoring, and/or displaying “liquidity risk,” means for measuring, monitoring, and/or displaying “settlement risk,” means for measuring, monitoring, and/or displaying “operational risk,” means for measuring, monitoring, and/or displaying “credit risk,” and means for measuring, monitoring, and/or displaying “systematic risk,” means for measuring, monitoring, and/or displaying “historical volatility,” and/or means for measuring, monitoring, and/or displaying “implied volatility,” and/or means for measuring, monitoring, and/or displaying “FX” and means for measuring, monitoring, and/or displaying “FX options,” and means for measuring, monitoring, and/or displaying “Margin trading,” and means for measuring, monitoring, and/or displaying “Fixed Income,” and means for measuring, monitoring, and/or displaying “Interest rate derivatives,” and means for measuring, monitoring, and/or displaying “Energy derivatives,” and means for measuring, monitoring, and/or displaying “Commodity and Metals trading and derivatives and Equity trading,”

### SUMMARY OF THE INVENTION

According to one aspect of the invention, a method is provided for renting, customizing, and delivering risk and/or volatility products to customers on a subscription basis. Up to a specified number of risk and/or volatility products are provided to the customer. In response to one or more risk and/or volatility product delivery criteria being satisfied (such as the payment of a specified fee), one or more other risk and/or volatility products are provided to the customer, wherein a total current one or more risk and/or volatility products provided to the customer can only be used during a specified time.

According to one aspect of the invention, a method is provided for renting, customizing, and delivering risk and/or volatility products to customers. Up to a specified number of risk and/or volatility products are provided to the customer. In response to one or more risk and/or volatility product delivery criteria being satisfied (such as the payment of a specified fee), one or more other risk and/or volatility products are provided to the customer, wherein a total current one or more risk and/or volatility products provided to the customer can only be used during a specified time.

According to another of the invention, a computer-implemented method is provided for renting, customizing, and delivering risk and/or volatility products to customers. According to the method, one or more risk and/or volatility product selection criteria are received that indicate one or more risk and/or volatility products that a customer desires to rent. Up to a specified number of the one or more risk and/or volatility products indicated by the one or more risk and/or volatility product selection criteria are provided to the customer. In response to one or more risk and/or volatility product delivery criteria being satisfied (such as the payment of a specified fee), one or more other risk and/or volatility products are provided to the customer, wherein a total current one or more risk and/or volatility products provided to the customer can only be used during a specified time.

According to another aspect of the invention, a computer-implemented method is provided for renting, customizing, and delivering risk and/or volatility products to customers. According to the method, one or more risk and/or volatility product selection criteria are received that indicate one or more risk and/or volatility products that a customer desires to rent. Up to a specified number of the one or more risk and/or volatility products indicated by the one or more risk and/or volatility product selection criteria are provided to the customer. In response to one or more risk and/or volatility product delivery criteria being satisfied (such as the payment of a specified fee), one or more other risk and/or volatility products are provided to the customer, wherein a total current one or more risk and/or volatility products provided to the customer can only be used during a specified time.

According to another aspect of the invention, a method is provided for renting, customizing, and delivering risk and/or volatility products to customers. Up to a specified number of risk and/or volatility products are provided to the customer. In response to one or more risk and/or volatility product delivery criteria being satisfied (such as the payment of a specified fee), one or more other risk and/or volatility products are provided to the customer, wherein a total current one or more risk and/or volatility products provided to the customer can only be used during a specified time.

According to another aspect of the invention, a method is provided for renting, customizing, and delivering one or more element selected from a group comprising of means for measuring, monitoring, and/or displaying “historical volatility,” and/or means for measuring, monitoring, and/or displaying “implied volatility” to customers. Up to a specified number of risk and/or volatility products are provided to the customer. In response to one or more said group product delivery criteria being satisfied (such as the payment of a specified fee), one or more other risk and/or volatility products are provided to the customer, wherein a total current one or more risk and/or volatility products provided to the customer can only be used during a specified time.

According to another aspect of the invention, a method is provided for renting, customizing, and delivering one or more element selected from a group comprising of means for measuring, monitoring, and/or displaying “liquidity risk,” means for measuring, monitoring, and/or displaying “settlement risk,” means for measuring, monitoring, and/or displaying “operational risk,” means for measuring, monitoring, and/or displaying “credit risk,” and means for measuring, monitoring, and/or displaying “systematic risk” to customers. Up to a specified number of risk and/or volatility products are provided to the customer. In response to one or more said group product delivery criteria being satisfied (such as the payment of a specified fee), one or more other risk and/or volatility products are provided to the customer, wherein a total current one or more risk and/or volatility products provided to the customer can only be used during a specified time.

According to another aspect of the invention, a method is provided for renting, customizing, and delivering one or more element selected from a group comprising of means for measuring, monitoring, and/or displaying “liquidity risk,” means for measuring, monitoring, and/or displaying “settlement risk,” means for measuring, monitoring, and/or displaying “operational risk,” means for measuring, monitoring, and/or displaying “credit risk,” and means for measuring, monitoring, and/or displaying “systematic risk” to customers.

According to another aspect of the invention, a method is provided for renting, customizing, and delivering one or more element selected from a group comprising of means for measuring, monitoring, and/or displaying “FX” and means for measuring, monitoring, and/or displaying “FX options,” and means for measuring, monitoring, and/or displaying “Margin trading,” and means for measuring, monitoring, and/or displaying “Fixed Income,” and means for measuring, monitoring, and/or displaying “Interest rate derivatives,” and means for measuring, monitoring, and/or displaying “Energy derivatives,” and means for measuring, monitoring, and/or displaying “Commodity and Metals trading and derivatives and Equity trading.”

Up to a specified number of risk and/or volatility products are provided to the customer. In response to one or more said group product delivery criteria being satisfied (such as the payment of a specified fee), one or more other risk and/or volatility products are provided to the customer, wherein a total current one or more risk and/or volatility products provided to the customer can only be used during a specified time.

According to another aspect of the invention, a computer-implemented method is provided for renting one or more element selected from a group comprising of means for measuring, monitoring, and/or displaying “historical volatility,” and/or means for measuring, monitoring, and/or displaying “implied volatility” to customers. According to the method, one or more said group selection criteria are received from a customer that indicates one or more risk and or volatility products that the customer desires to rent. Up to a specified number of the one or more said indicated by the one or more risk and/or volatility selection criteria are provided to the customer. In response to one or more risk and/or volatility product delivery criteria being satisfied (such as the payment of a specified fee), one or more other risk and/or volatility products are provided to the customer, wherein a total current one or more risk and/or volatility products provided to the customer can only be used during a specified time.

According to another aspect of the invention, a computer-implemented method is provided for renting one or more element selected from a group comprising of means for measuring, monitoring, and/or displaying “liquidity risk,” means for measuring, monitoring, and/or displaying “settlement risk,” means for measuring, monitoring, and/or displaying “operational risk,” means for measuring, monitoring, and/or displaying “credit risk,” and means for measuring, monitoring, and/or displaying “systematic risk” to customers. According to the method, one or more said group selection criteria are received from a customer that indicates one or more risk and or volatility products that the customer desires to rent. Up to a specified number of the one or more said indicated by the one or more risk and/or volatility product selection criteria are provided to the customer. In response to one or more risk and/or volatility product delivery criteria being satisfied (such as the payment of a specified fee), one or more other risk and/or volatility products are provided to the customer, wherein a total current one or more risk and/or volatility products provided to the customer can only be used during a specified time.

According to another aspect of the invention, an apparatus for renting, customizing, and delivering risk and/or volatility products risk and/or volatility products to customers is provided. The apparatus comprises one or more processors and a memory communicatively coupled to the one or more processors. The memory includes one or more sequences of one or more instructions which, when executed by the one or more processors, cause the one or more processors to perform several steps. First, one or more risk and/or volatility product selection criteria are received that indicate one or more risk and/or volatility products that a customer desires to rent. Up to a specified number of the one or more risk and/or volatility products indicated by the one or more risk and/or volatility product selection criteria are provided to the customer. Finally, in response to one or more risk and/or volatility product delivery criteria being satisfied (such as the payment of a specified fee), one or more other risk and/or volatility products are provided to the customer, wherein a total current one or more risk and/or volatility products provided to the customer can only be used during a specified time.

According to another aspect of the invention, an apparatus is provided for renting, customizing, and delivering risk and/or volatility products to customers. The apparatus comprises a risk and/or volatility product rental mechanism configured to receive one or more risk and/or volatility product selection criteria that indicate one or more risk and/or volatility products that a customer desires to rent. The risk and/or volatility product rental mechanism is also configured to provide to the customer up to a specified number of the one or more risk and/or volatility products indicated by the one or more risk and/or volatility product selection criteria. Finally, the risk and/or volatility product rental mechanism is configured to in response to one or more risk and/or volatility product delivery criteria being satisfied (such as the payment of a specified fee), one or more other risk and/or volatility products are provided to the customer, wherein a total current one or more risk and/or volatility products provided to the customer can only be used during a specified time.

In the foregoing specification, the invention has been described with reference to specific embodiments thereof. However, various modifications and changes may be made thereto without departing from the broader spirit and scope of the invention. The specification and drawings are, accordingly, to be regarded in an illustrative sense rather than a restrictive sense.

Many modifications and alterations may be made by those having ordinary skill in the art without departing from the spirit and scope of the invention. Therefore, it must be understood that the embodiment illustrations has been set forth only for the purposes of example and that it should not be taken as limiting the invention as defined by the following claims. For example, notwithstanding the fact that the elements of a claim are set forth below in an obvious combination, it must be expressly understood that the invention includes other combinations of fewer, more or different elements, which are disclosed in above even when not initially claimed in such combinations.

The claims are thus to be taught to include what is specifically illustrated and described above, what is an equivalent concept, what can be obviously substituted and also what essentially incorporates the essential idea of the invention.

### BRIEF DESCRIPTION OF THE DRAWING

Embodiments of the invention are illustrated by way of example, and not by way of limitation, in the figures of the accompanying drawings and in which like reference numerals refer to similar elements and in which:

FIG. 1 is a diagram depicting an approach for renting risk and/or volatility products to customers according to an embodiment.

FIG. 2 is a flow diagram depicting an approach for renting risk and/or volatility products to customers according to an embodiment.

FIG. 3 is a flow diagram depicting a “Specific Time Limit” approach for renting risk and/or volatility products to customers according to an embodiment.

FIG. 4 is a flow diagram depicting a “Negotiated Time Limit with Intermediate” approach for renting risk and/or volatility products to customers according to an embodiment.

FIG. 5 is a diagram depicting an approach for renting risk and/or volatility products to customers over the Internet according to an embodiment.

FIG. 6 is a flow diagram illustrating an approach for renting risk and/or volatility products to customers over the Internet using both “Specific Time Limit” and “Negotiated Time Limit with Intermediate” according to an embodiment; and

FIG. 7 is a block diagram of a data processing system upon which embodiments of the invention may be implemented.

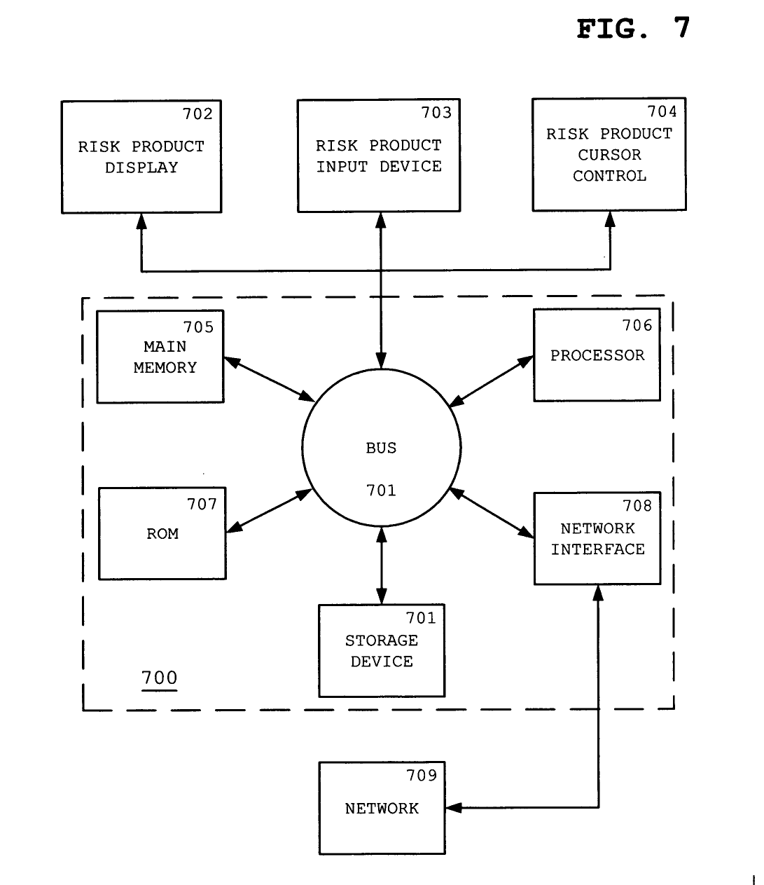

FIG. 8 is a block diagram of a risk and/or volatility product producer system upon which embodiments of the invention may be implemented.

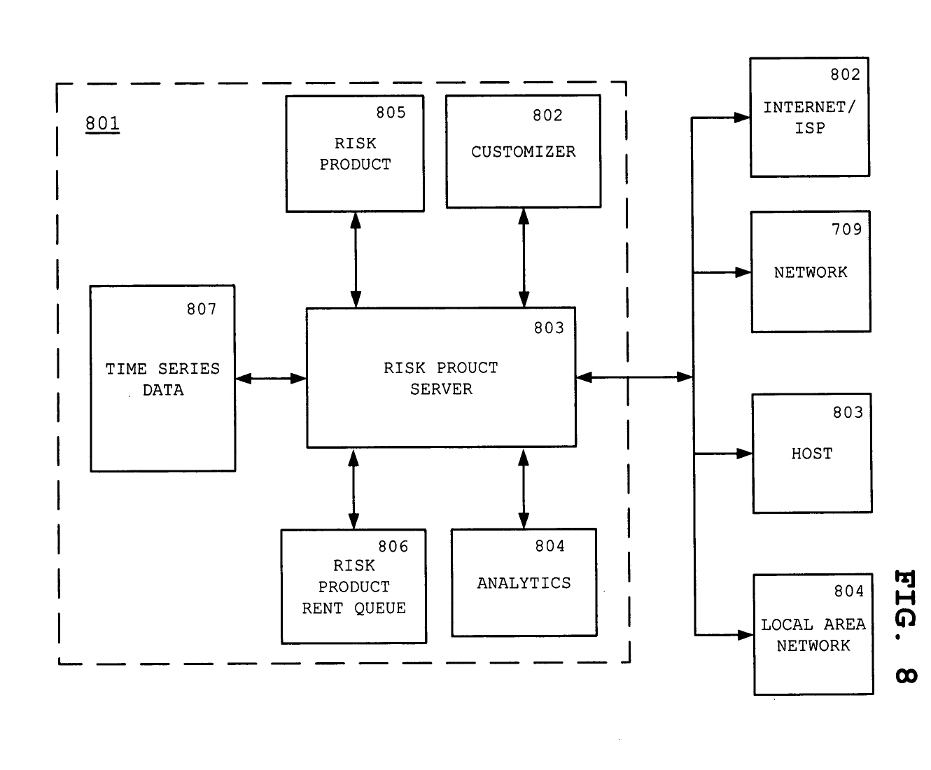

### DETAILED DESCRIPTION OF THE INVENTION

In the following description, reference will now be made in detail to the presently preferred embodiments of the invention, examples of which are illustrated in the accompanying drawings. Well-known structures and devices are depicted in block diagram form in order to avoid unnecessarily obscuring the invention. Yet, it will be apparent that the invention may be practiced without these specific details.

Various aspects and features of example embodiments of the invention are described in more detail hereinafter in the following sections: (1) utilitarian overview; (2) risk and/or volatility products selection criteria; (3) risk and/or volatility products delivery; (4) “Specific Time Limit”; (5) “Negotiated Time Limit with Intermediate”; (6) register management; (7) implementation equipment, and (8) provider services.

1. Utilitarian Overview

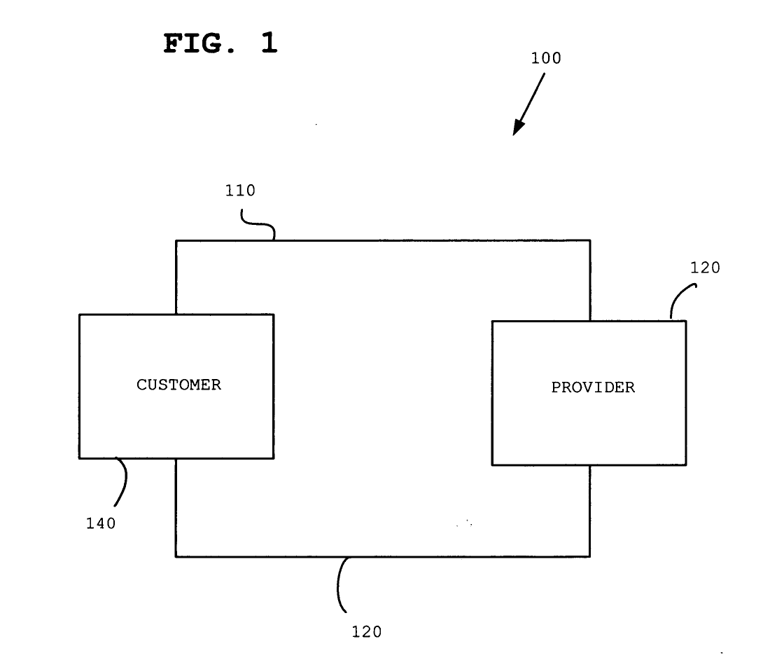

FIG. 1 is a block diagram 100 that illustrates an approach for renting risk and/or volatility products to customers according to various embodiments described herein. As used herein, the term “risk and/or volatility product” refers to any commercial risk and/or volatility measurement and/or monitoring electronic work that can be rented to customers. Examples of risk and/or volatility products include means for measuring and/or monitoring credit risk, liquidity risk, settlement risk, operational risk, and systematic risk, and/or means for measuring and/or monitoring historical volatility and implied volatility stored on a non-volatile memory such as a tape, other magnetic medium, optical medium, read-only memory or the like, and the invention is not limited to any particular type of risk and/or volatility product. In general, the decision of what risk and/or volatility products to rent is separated from the decision of when to rent the risk and/or volatility products. Customers may specify what risk and/or volatility products to rent using one or more risk and/or volatility product selection criteria separate from deciding when to receive the specified risk and/or volatility products. Furthermore, customers are not constrained by conventional rental “shopping carts” and instead can have continuous, serialized rental of risk and/or volatility products.

According to one embodiment, a customer 140 provides one or more risk and/or volatility product selection criteria to a provider 120 over a link 110. Link 110 may be any medium for transferring data between customer 140 and provider 120.

The risk and/or volatility product selection criteria indicate risk and/or volatility products that customer 140 desires to rent from provider 120. In response to receiving the risk and/or volatility product selection criteria from customer 140, provider 120 provides the risk and/or volatility products indicated by the risk and/or volatility product selection criteria to customer 140 over a delivery channel 120. Delivery channel 120 may be implemented by any mechanism or medium that provides for the transfer of risk and/or volatility products from provider 120 to customer 140 and the invention is not limited to any particular type of delivery channel. Examples of delivery channel 120 include delivery using the Internet. Provider 120 may be centralized or distributed depending upon the requirements of a particular application.

According to an embodiment, a “Specific Time Limit” approach allows up to a specified number of risk and/or volatility products to be rented simultaneously to customer 140 by provider 120. According to another embodiment, a “Negotiated Time Limit with Intermediate” approach allows up to a specified number of risk and/or volatility product exchanges to occur during a specified period of time. The “Specific Time Limit” and “Negotiated Time Limit with Intermediate” approaches may be used together or separately with a variety of subscription methodologies.

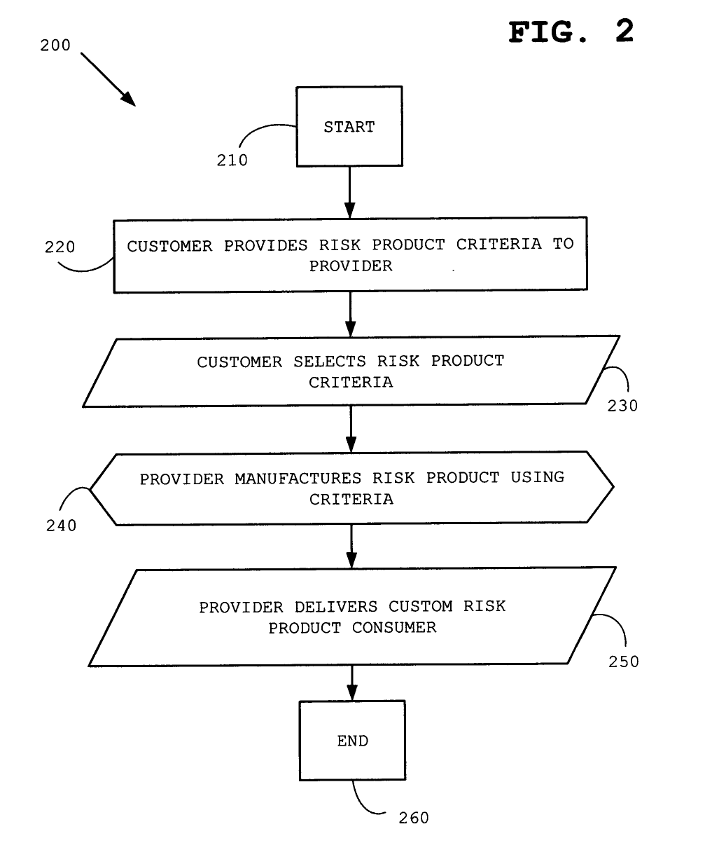

The approach just described for renting risk and/or volatility products to customers is now described with reference to a flow diagram 200 of FIG. 2. After starting in step 202, in step 204, customer 140 creates risk and/or volatility product selection criteria. In step 206, customer 140 provides the risk and/or volatility product selection criteria to provider 120. In step 208, in response to provider 120 receiving the risk and/or volatility product selection criteria from customer 140, provider 120 provides one or more risk and/or volatility products indicated by the risk and/or volatility product selection criteria to customer 140. The process is complete in step 210.

2. Risk and/or Volatility Product Selection Criteria

The one or more risk and/or volatility product selection criteria provided by customer 140 to provider 120 indicate the particular risk and/or volatility products that customer 140 desires to rent from provider 120. Thus, the risk and/or volatility product selection criteria define a customer-specific order queue that is fulfilled by provider 120. According to one embodiment, the risk and/or volatility product selection criteria specify attributes of risk and/or volatility products to be provided by provider 120 to customer 140. Risk and/or volatility product selection criteria may specify any type of risk and/or volatility product attributes and the invention is not limited to particular risk and/or volatility product attributes. Examples of risk and/or volatility product attributes include, without limitation, identifier attributes, type attributes and cost attributes. Risk and/or volatility product selection criteria may be changed at any time to reflect changes in risk and/or volatility products that customers desire to rent from a provider.

3. Risk and/or Volatility Product Delivery

According to one embodiment, risk and/or volatility products are delivered by provider 120 to customer 140 over delivery channel 120 based upon risk and/or volatility product delivery criteria. More specifically, the delivery of risk and/or volatility products from provider 120 to customer 140 is triggered by risk and/or volatility product delivery criteria being satisfied. The risk and/or volatility product delivery criteria may include a wide range of Internet delivery criteria and the invention is not limited to any particular risk and/or volatility product delivery criteria. Examples of risk and/or volatility product delivery criteria include, without limitation, customer messaging, customer web services, customer remote method invocation, customer p2p, and customer email.

The risk and/or volatility product delivery criteria may be specified by customer 140 to provider 120 or negotiated by customer 140 and provider 120 as part of a subscription service. For example, a particular subscription service may include risk and/or volatility product delivery criteria that specifies that a particular number of risk and/or volatility products are to be delivered monthly. As another example, risk and/or volatility product delivery criteria may specify that an initial set of risk and/or volatility products is to be delivered by provider 120 to customer 140 upon initiation of a subscription service and that additional risk and/or volatility products are to be delivered to customer 140 upon return of risk and/or volatility products to provider 120. Risk and/or volatility product delivery criteria may be applied uniformly to all risk and/or volatility products to be delivered to a customer, or may be risk and/or volatility product specific. For example, risk and/or volatility product delivery criteria may specify a particular date, i.e., the third Wednesday of every month, for all risk and/or volatility product deliveries. Alternatively, separate risk and/or volatility product delivery dates may be assigned to each risk and/or volatility product.

4. “Specific Time Limit”

According to one embodiment, a “Specific Time Limit” approach is used to manage the number of risk and/or volatility products that may be simultaneously rented to customers. According to the “Specific Time Limit” approach, up to a specified number of risk and/or volatility products may be rented simultaneously to a customer. Thus, the “Specific Time Limit” approach establishes the size of an register of risk and/or volatility products that may be maintained by customers. The specified number of risk and/or volatility products may be specific to each customer or may be common to one or more customers. In the present example, if the specified number of risk and/or volatility products is nine, then up to nine risk and/or volatility products may be rented simultaneously by provider 120 to customer 140. If the specified number of risk and/or volatility products are currently rented to customer 140 and the specified risk and/or volatility product delivery criteria triggers the delivery of one or more additional risk and/or volatility products, then those risk and/or volatility products are not delivered until one or more risk and/or volatility products are returned by customer 140 to provider 120.

According to one embodiment, in situations where the specified number of risk and/or volatility products are currently rented to customer 140 and the specified risk and/or volatility product delivery criteria triggers the delivery of one or more additional risk and/or volatility products, then the one or more additional risk and/or volatility products are delivered to customer 140 and customer 140 and a surcharge is applied customer 140. The specified number of risk and/or volatility products may then be increased thereafter to reflect the additional risk and/or volatility products delivered to customer 140 and increase the size of the register maintained by customer 140. Alternatively, the specified number of risk and/or volatility products may remain the same and number of risk and/or volatility products maintained by customer 140 returned to the prior level after risk and/or volatility products are returned to provider 120 by customer 140. When used in conjunction with the “Negotiated Time Limit with Intermediate” approach described hereinafter, the specified number of risk and/or volatility products may be unlimited.

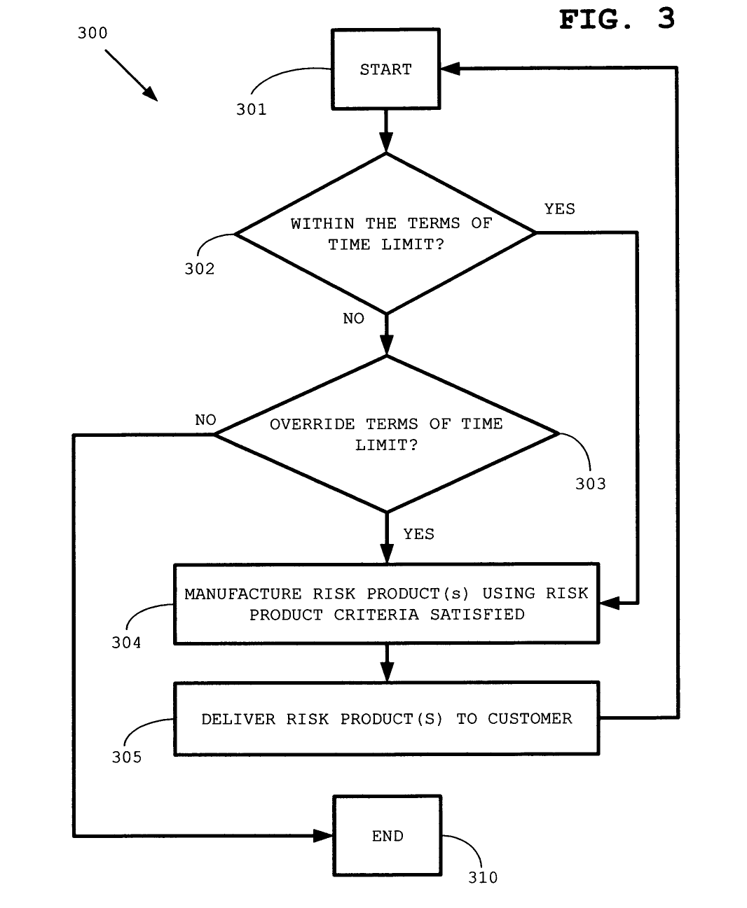

The “Specific Time Limit” approach for managing the number of risk and/or volatility products that may be simultaneously rented to customers is now described with reference to a flow diagram 300 of FIG. 3. After starting in step 302, in step 304, one or more initial risk and/or volatility products are delivered to customer 140 to establish the register maintained by customer 140. Note that an initial delivery of risk and/or volatility products is not required and according to one embodiment, the register of customer 140 is incrementally established over time.

In step 306, a determination is made whether the risk and/or volatility product delivery criteria have been satisfied. If not, then the determination continues to be made until the risk and/or volatility product delivery criteria are satisfied. As described previously herein, the delivery criteria may include customer notification generally, customer notification that an risk and/or volatility product is being returned, the actual return of an risk and/or volatility product, the occurrence of a specific date, or that a specified amount of time has elapsed.

Once the risk and/or volatility product delivery criteria are satisfied, then in step 308, a determination is made whether the specified number of risk and/or volatility products have been delivered. If not, then control returns to step 304 and one or more additional risk and/or volatility products are delivered by provider 120 to customer 140. If however, in step 308, the specified number of risk and/or volatility products have been delivered, then in step 310, a determination is made whether the specified number of risk and/or volatility products, i.e., the “Specific Time Limit” limit, is to be overridden. As previously described, the specified number of risk and/or volatility products may be overridden by increasing the specified number of risk and/or volatility products, i.e., the “Specific Time Limit” limit, to allow additional risk and/or volatility products to be delivered to customer 140 and charging a fee to customer 140. Alternatively, the specified number of risk and/or volatility products is not changed and a surcharge applied to customer 140. This process continues for the duration of the subscription and is then complete in step 310.

5. “Negotiated Time Limit with Intermediate”

According to one embodiment, a “Negotiated Time Limit with Intermediate” approach is used to rent risk and/or volatility products to customers. According to the “Negotiated Time Limit with Intermediate” approach, up to a specified number of risk and/or volatility product exchanges may be performed during a specified period of time. For example, referring to FIG. 1, suppose that provider 120 agrees to rent risk and/or volatility products to customer 140 with a “Negotiated Time Limit with Intermediate” limit of nine risk and/or volatility products per month. This means that customer 140 may make up to nine risk and/or volatility product exchanges per month. This approach may be implemented independent of the number of risk and/or volatility products that a customer may have rented at any given time under the “Specific Time Limit” approach. The approach is also independent of the particular risk and/or volatility product delivery criteria used.

According to one embodiment, the “Negotiated Time Limit with Intermediate” approach is implemented in combination with the “Specific Time Limit” approach to rent risk and/or volatility products to customers. In this situation, up to a specified number of total risk and/or volatility products are simultaneously rented to customer 140 and up to a specified number of risk and/or volatility product exchanges may be made during a specified period of time. Thus, using the “Specific Time Limit” and the “Negotiated Time Limit with Intermediate” approaches together essentially establishes a personal risk and/or volatility product register for customer 140 based upon the “Specific Time Limit” limit that may be periodically refreshed based upon the “Negotiated Time Limit with Intermediate” limit selected.

In some situations, customer 140 may wish to exchange more than the specified number of risk and/or volatility products during a specified period. According to one embodiment, in this situation, provider 120 agrees to rent additional risk and/or volatility products above the specified number to customer 140 and to charge customer 140 for the additional risk and/or volatility products. For example, suppose that provider 120 agrees to rent risk and/or volatility products to customer 140 with up to nine risk and/or volatility product turns (exchanges) per month. If, in a particular month, customer 140 requires two additional turns, then the two additional risk and/or volatility products are provided to customer 140 and a surcharge is applied to customer 140 for the additional two risk and/or volatility products.

In other situations, customer 140 may not use all of its allotted turns during a specified period. According to one embodiment, customers lose unused turns during a subscription period. For example, if customer 140 has a “Negotiated Time Limit with Intermediate” limit of four risk and/or volatility product exchanges per month and only makes two risk and/or volatility product exchanges in a particular month, then the two unused exchanges are lost and cannot be used. At the start of the next month, customer 140 would be entitled to four new risk and/or volatility product exchanges.

According to another embodiment, customers are allowed to carry over unused turns to subsequent subscription periods. For example, if customer 140 has a “Negotiated Time Limit with Intermediate” limit of four risk and/or volatility product exchanges per month and only makes two risk and/or volatility product exchanges in a particular month, then the two unused exchanges are lost and cannot be used. At the start of the next month, customer 140 would be entitled to six new risk and/or volatility product exchanges, two from the prior month and four for the current month.

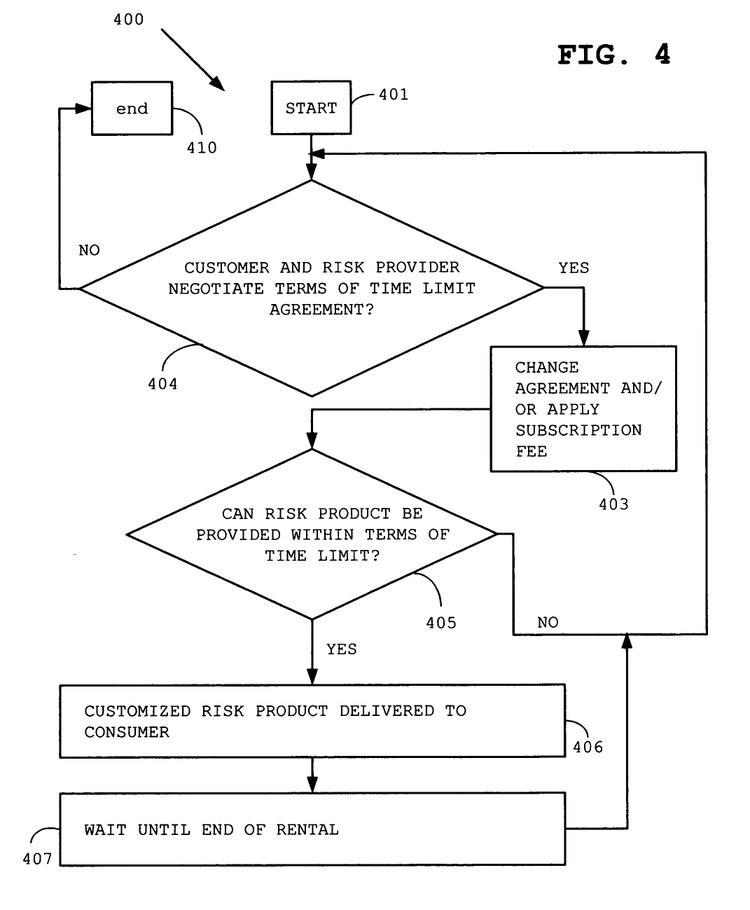

The “Negotiated Time Limit with Intermediate” approach for renting risk and/or volatility products to customers is now described with reference to a flow diagram 400 of FIG. 4. After starting in step 401, in step 404, customer 140 and provider 120 agree upon the terms of the “Negotiated Time Limit with Intermediate” agreement. Specifically, customer 140 and provider 120 negotiate a time limit.

In step 405, in response to risk product being provided within terms of time limit, provider 120 provides one or more risk and/or volatility products to customer 140 over delivery channel 120. Any type of risk and/or volatility product delivery criteria may be used with the “Negotiated Time Limit with Intermediate” approach and the invention is not limited to any particular delivery criteria. For example, the initial one or more risk and/or volatility products may be delivered to customer 140 in response to a subscription payment made by customer 140 to provider 120, the initiation of a specified subscription period, or by request of customer 140 for the initial rental risk and/or volatility products. The availabilty of initial one or more risk and/or volatility products must not exceed the terms of the “Negotiated Time Limit with Intermediate” agreement.

In step 408, in response to one or more delivery criteria being satisfied, a determination is made whether additional risk and/or volatility products can be provided to customer 140 within the terms of the “Negotiated Time Limit with Intermediate” agreement. For example, if the number of risk and/or volatility products rented to customer in the current subscription period is less than the agreed-upon “Negotiated Time Limit with Intermediate,” then additional risk and/or volatility products can be rented to customer 140 within the terms of the “Negotiated Time Limit with Intermediate” agreement. In this situation, this determination may be made in response to customer 140 returning one or more risk and/or volatility products to provider 120, or by customer 140 requesting additional risk and/or volatility products.

If, in step 405, a determination is made that additional risk and/or volatility products can be rented to customer 140 within the terms of the “Terms of a Time Limit” agreement, then control returns to step 406 where one or more additional risk and/or volatility products are delivered to customer 140. If however, in step 404, a determination is made that customer 140 AND provider 120 CANNOT NEGOTITATE A TIME LIMIT AGREEMENT, then in step 403, a determination is made whether to override the current agreement terms. If so, then in step 403, the agreement terms are changed to allow for a larger number of terms and customer 140 is charged accordingly, or the terms are left unchanged and a surcharge is applied for the additional risk and/or volatility products to be delivered. Control then returns to step 405, where a determination is made whether the risk product can be provided to customer 140 within terms of a time limit.

If in step 410, a determination is made that the risk product can be provided within the terms of a time limit, then in step 406, risk and/or volatility products are delivered to customer 140 until the next subscription period. For example, the request for additional risk and/or volatility products may be received at the end of a subscription period and instead of renting the additional risk and/or volatility products immediately, they are instead delivered during the subsequent subscription period. Control then returns to step 404 where one or more additional risk and/or volatility products are rented to customer or the process is complete in step 410.

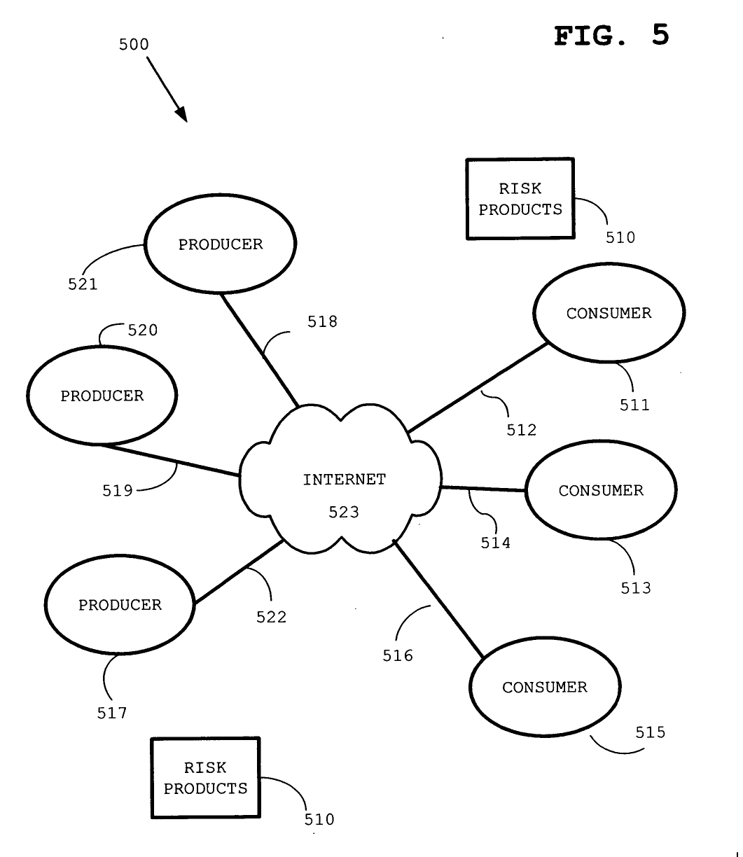

The approach for renting risk and/or volatility products described herein is now described in the context of renting to customers risk and/or volatility products, such as a means for measuring and/or monitoring credit risk, liquidity risk, settlement risk, operational risk, and systematic risk, and/or means for measuring and/or monitoring historical volatility and f implied volatility. FIG. 5 is a diagram 500 that depicts a set of customers 511 that desire to rent risk and/or volatility products from a set of providers 521. Customers 511 communicate with providers 521 over links 512, the global packet-switched network referred to as the “Internet,” and a link 518.

Links 512 and 518 may be any medium for transferring data between customers 511 and the Internet 523 and between the Internet 523 and providers 521, respectively, and the invention is not limited to any particular medium. In the present example, links 512 and 518 may be connections provided by one or more Internet Service Providers (ISPs) and customers 511 are configured with generic Internet web browsers. Links 512 and 518 may be secure or unsecured depending upon the requirements of a particular application.

In accordance with an embodiment, customers 511 enter into a rental agreement with providers 521 to rent risk and/or volatility products 510 from providers 521 according to the “Specific Time Limit” and/or “Negotiated Time Limit with Intermediate” approaches described herein. No limiting to any particular approach for entering into the rental agreement is placed on the invention. For example, customers 511 and providers 521 may enter into a rental agreement by fax, mail, telephone or over the Internet, by customers 511 logging into a web site associated with providers 521.

Customers 511 create and provide risk and/or volatility product selection criteria to providers 521 over links 512 and 518 and the Internet 523. The invention is not limited to any particular approach for specifying and providing risk and/or volatility product selection criteria to providers 521. For example, according to one embodiment, customers 511 provide risk and/or volatility product selection criteria to providers 521 in one or more data files. According to another embodiment, customers 511 log onto a web site of providers 521 and use a graphical user interfaced (GUI) to specify attributes of the risk and/or volatility product that customers desire to rent from providers 521.

The risk and/or volatility product selection attributes may include any attributes that describe, at least in part, risk and/or volatility product that customers 511 desire to rent. Customers 511 may identify specific risk and/or volatility product by the risk and/or volatility product selection criteria, or may provide various attributes and allow providers 521 to automatically manufacture and deliver risk and/or volatility product that satisfy the attributes specified.

Once customers 511 and providers 521 have entered into a rental agreement and customers 511 have provided risk and/or volatility product selection criteria to providers 521, then risk and/or volatility products 510 are rented to customers 511 over delivery channels 514 in accordance with the terms of the rental agreement. Specifically, according to the “Specific Time Limit” approach described herein, an initial set of risk and/or volatility products 510, such as means for measuring, monitoring, and/or displaying “liquidity risk,” means for measuring, monitoring, and/or displaying “settlement risk,” means for measuring, monitoring, and/or displaying “operational risk,” means for measuring, monitoring, and/or displaying “credit risk,” and means for measuring, monitoring, and/or displaying “systematic risk,” means for measuring, monitoring, and/or displaying “historical volatility,” and/or means for measuring, monitoring, and/or displaying “implied volatility,” and/or means for measuring, monitoring, and/or displaying “FX” and means for measuring, monitoring, and/or displaying “FX options,” and means for measuring, monitoring, and/or displaying “Margin trading,” and means for measuring, monitoring, and/or displaying “Fixed Income,” and means for measuring, monitoring, and/or displaying “Interest rate derivatives,” and means for measuring, monitoring, and/or displaying “Energy derivatives,” and means for measuring, monitoring, and/or displaying “Commodity and Metals trading and derivatives and Equity trading,”

are delivered to customers 511 over delivery channels 514 according to the terms of the rental agreement. Subsequent risk and/or volatility products 510 are delivered whenever the specified risk and/or volatility product delivery criteria are satisfied. For example, additional risk and/or volatility products 510 may be delivered upon the return of one or more risk and/or volatility products 510 to provider, a request from customers 511, the arrival of a particular date, e.g., a specific day of the month, or the expiration of a specified period of time, e.g., fifteen days.

In accordance with the “Specific Time Limit” approach described herein, once the maximum number of risk and/or volatility products 510 have been rented to a particular consumers 511, then no additional risk and/or volatility products 510 are rented until one or more rented risk and/or volatility products 510 are returned to providers 521, or unless a surcharge is applied to the particular consumers 511. Alternatively, the rental agreement between the particular consumers 511 and providers 521 may be modified to increase the maximum number of risk and/or volatility products 510 that may be rented simultaneously to the particular consumers 511.

The rental agreement between customers 511 and providers 521 may also specify a maximum number of turns in combination with the “Specific Time Limit” approach. In this situation, a specific time limit restricts how quickly customers 511 may refresh their risk and/or volatility product 512 out baskets. For example, suppose that a particular consumers 511 agrees with providers 521 to rent up to four risk products with a time limit of 3 month. Under this agreement, the particular consumers 511 may maintain a personal register of up to four risk products for 3 months. Thus, the particular consumers 511 can completely “replace” his personal register once per month. If the particular consumers 511 agreed to a specific time limit of 2 months, then the particular consumers 511 would be able to completely replace his personal register for two months.

Providers 521 may be centralized or distributed depending upon the requirements of a particular application. For example, providers 521 may be a centralized data processing center from which all risk and/or volatility products 510 are manufactured and delivered. Alternatively, providers 521 may be implemented by a network of distributed data processing center.

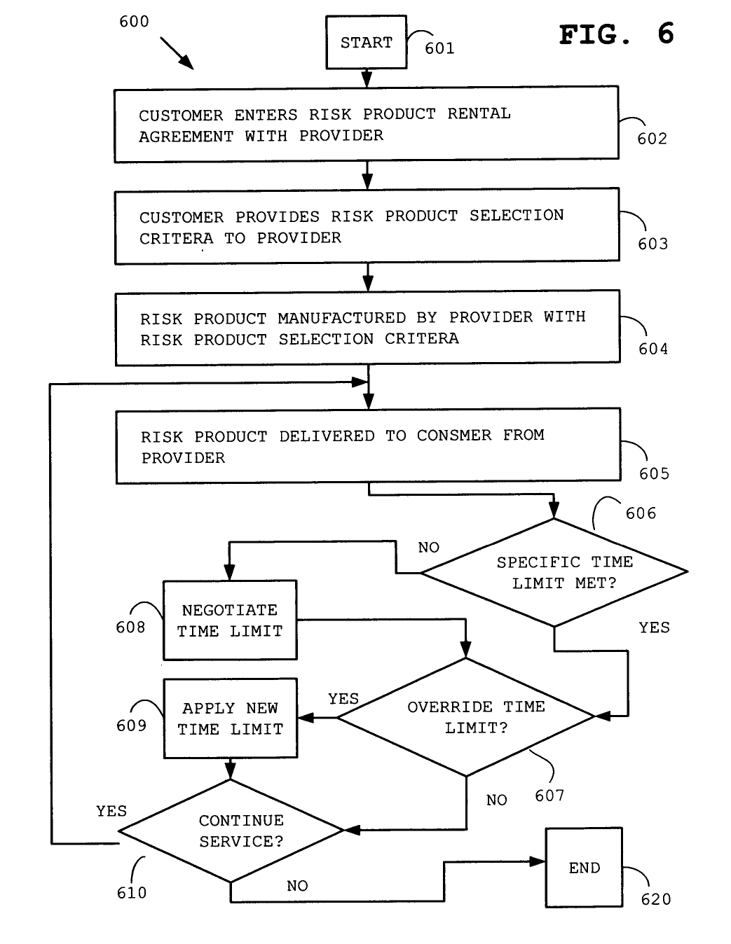

FIG. 6 is a flow diagram that illustrates an approach for renting risk and/or volatility products 510 to customers over a communications network such as the Internet using both “Specific Time Limit” and “Negotiated Time Limit with Intermediate” according to an embodiment. Referring also to FIG. 5, after starting in step 601, in step 602, a consumers 511 enters into a rental agreement with providers 521. In the present example, consumers 511 uses a generic web browser to access an Internet web site associated with providers 521 and enter into a rental agreement that specifies that consumers 511 may maintain a personal register of four risk products for 1 month (“Specific Time Limit” of 1 month).

What is claimed is:

1. A method for renting, manufacturing, intermediating, and delivering risk and/or volatility products to customers, the method comprising the computer-implemented steps of:
receiving a one or risk and/or volatility product selection criteria that indicates one or more risk and/or volatility products that a customer desires to rent;
providing to the customer the one or risk and/or volatility product selection criteria indicated by the one or more risk and/or volatility product selection criteria;
manufacturing a one or more risk and/or volatility products by applying the one or risk and/or volatility product selection criteria to a one or more producers;
intermediating a one or more risk and/or volatility products by applying the one or risk and/or volatility product selection criteria to a one or more producers;
delivering the one or more risk and/or volatility products by the one or more producers over a delivery channel;
in response to receiving any of the one or risk and/or volatility product selection criteria that indicates one or more risk and/or volatility products, providing to the customer the one or risk and/or volatility product selection criteria indicated by the one or risk and/or volatility product selection criteria, manufacturing a one or more risk and/or volatility products by applying the one or risk and/or volatility product selection criteria to the one or more producers, delivering the one or more risk and/or volatility products by the one or more producers over a delivery channel, wherein a total current one or more risk and/or volatility products provided to the customer does not exceed a specified time limit.

2. A method as recited in claim 1, wherein the one or more risk and/or volatility products provided to the customer can only be used for a specified time limit.

3. A method as recited in claim 2, further comprising in response to a specified fee being received, the specified time limit is increased for another specified limit.

4. A method as recited in claim 1, wherein
the one or more risk and/or volatility product selection criteria indicates a desired order for the one or more risk and/or volatility products that a customer desires to rent,
the step of providing to the customer up to a determined number of the one or more of customizable risk and/or volatility products indicated by the one or risk and/or volatility product selection criteria includes providing to the customer up to a one or more of customized risk and/or volatility products indicated by the one or risk and/or volatility product selection criteria in the desired order indicated by the risk and/or volatility product selection criteria, and
the step of providing to the customer one or more of customized risk and/or volatility products indicated by the one or risk and/or volatility product selection criteria includes providing to the customer one or more of customized risk and/or volatility products indicated by one or risk and/or volatility product selection criteria in the desired order indicated by the one or risk and/or volatility product selection criteria.

5. A method as recited in claim 1, wherein
the one or more risk and/or volatility product selection criteria corresponds to one or more risk and/or volatility product attributes,
the step of providing to the customer up to a specified number of the one or more risk and/or volatility products indicated by the one or more risk and/or volatility product selection criteria includes automatically selecting and providing to the customer up to a specified number of one or more risk and/or volatility products that have one or more of the one or more risk and/or volatility product attributes specified by the one or more risk and/or volatility product selection criteria, and
the step of providing to the customer one or more other risk and/or volatility products indicated by the one or more risk and/or volatility product selection criteria includes automatically manufacturing and providing to the customer one or more risk and/or volatility products that have one or more of the selected risk and/or volatility product attributes specified by the one or more risk and/or volatility product selection criteria.

6. A method as recited in claim 5, wherein providing a one or more risk and/or volatility product selection criteria corresponding to risk and/or volatility product attributes comprises conforming said options to production capabilities of the one or more producers.

7. A method as recited in claim 1, wherein
the applying the one or risk and/or volatility product selection criteria to a one or more producers indicates a customized risk and/or volatility product for the one or more risk and/or volatility products that one or more producers produce,
the step of manufacturing a one or more risk and/or volatility products by applying the one or risk and/or volatility product selection criteria to one or more producers includes receiving to the one or more producers up to the one or risk and/or volatility product selection criteria indicated by the one or risk and/or volatility product selection criteria in the desired order indicated by the risk and/or volatility product selection criteria, and
the step of manufacturing a one or more risk and/or volatility products by applying the one or risk and/or volatility product selection criteria to one or more producers includes automatic manufacturing by the one or more producers the one or more risk and/or volatility products that have the one or more preferred risk and/or volatility product attributes specified by the one or more risk and/or volatility product selection criteria.

9. A method as recited in claim 7, wherein applying the one or risk and/or volatility product selection criteria to one or more producers comprises manufacturing a specified number of risk and/or volatility products indicated by the customer's order.

10. The method in claim 1 further comprising receiving said selected option from the consumer to the one or more producers.

11. The method in claim 10 wherein said manufacturing a selected option into at least one machine instruction comprises manufacturing said selected option into at least one machine instruction at the producer.

12. A method as recited in claim 1,
further comprising:
establishing, based upon the risk and/or volatility product selection criteria, a risk and/or volatility product rental queue for the customer, wherein the risk and/or volatility product rental queue contains one or more entries that specify the one or more of customized risk and/or volatility products that the customer desires to rent.

13. A method as recited in claim 1,
further comprising in response to a specified fee being received, providing to the customer a time extension for using the one or more of customized risk and/or volatility products indicated by the one or risk and/or volatility product selection criteria.

14. A method as recited in claim 1,
further comprising in response to an expiration of a predetermined time limit, suspending in response to a signal the set of one or more of customized risk and/or volatility products indicated by the one or risk and/or volatility product selection criteria.

15. A method as recited in claim 1, wherein risk and/or volatility products are provided by provider to the customer over the Internet.

16. A method as recited in claim 1, wherein:
the one or more risk and/or volatility products are one or more element selected from a group comprising of means for measuring, monitoring, and/or displaying “liquidity risk,” means for measuring, monitoring, and/or displaying “settlement risk,” means for measuring, monitoring, and/or displaying “operational risk,” means for measuring, monitoring, and/or displaying “credit risk,” and means for measuring, monitoring, and/or displaying “systematic risk,” means for measuring, monitoring, and/or displaying “historical volatility,” and/or means for measuring, monitoring, and/or displaying “implied volatility,” and/or means for measuring, monitoring, and/or displaying “FX” and means for measuring, monitoring, and/or displaying “FX options,” and means for measuring, monitoring, and/or displaying “Margin trading,” and means for measuring, monitoring, and/or displaying “Fixed Income,” and means for measuring, monitoring, and/or displaying “Interest rate derivatives,” and means for measuring, monitoring, and/or displaying “Energy derivatives,” and means for measuring, monitoring, and/or displaying “Commodity and Metals trading and derivatives and Equity trading,”
the one or more risk and/or volatility product selection criteria are one or more of the group selection criteria,
the step of receiving a one or risk and/or volatility product selection criteria that indicates one or more risk and/or volatility products that a customer desires to rent;
the step of providing to the customer the one or risk and/or volatility product selection criteria indicated by the one or more risk and/or volatility product selection criteria;
the step of manufacturing a one or more risk and/or volatility products by applying the one or risk and/or volatility product selection criteria to a one or more producers;
the step of in response to receiving any of the one or risk and/or volatility product selection criteria that indicates one or more risk and/or volatility products, providing to the customer the one or risk and/or volatility product selection criteria indicated by the one or risk and/or volatility product selection criteria, manufacturing a one or more risk and/or volatility products by applying the one or risk and/or volatility product selection criteria to the one or more producers, delivering the one or more risk and/or volatility products by the one or more producers over a delivery channel, wherein a total current one or more risk and/or volatility products provided to the customer does not exceed a specified time limit.

17. A computer-readable medium for renting, manufacturing, and delivering risk and/or volatility products to customers, the computer-readable medium carrying one or more sequences of one or more instructions which, when executed by one or more processors, cause the one or more processors to perform the computer-implemented steps of:
receiving a one or risk and/or volatility product selection criteria that indicates one or more risk and/or volatility products that a customer desires to rent;
providing to the customer the one or risk and/or volatility product selection criteria indicated by the one or more risk and/or volatility product selection criteria;
manufacturing a one or more risk and/or volatility products by applying the one or risk and/or volatility product selection criteria to a one or more producers;
intermediating a one or more risk and/or volatility products by applying the one or risk and/or volatility product selection criteria to a one or more producers;
delivering the one or more risk and/or volatility products by the one or more producers over a delivery channel;
in response to receiving any of the one or risk and/or volatility product selection criteria that indicates one or more risk and/or volatility products, providing to the customer the one or risk and/or volatility product selection criteria indicated by the one or risk and/or volatility product selection criteria, manufacturing a one or more risk and/or volatility products by applying the one or risk and/or volatility product selection criteria to the one or more producers, delivering the one or more risk and/or volatility products by the one or more producers over a delivery channel, wherein the one or more risk and/or volatility products provided to the customer can only be used for a specified time limit.

18. A computer-readable medium as recited in claim 17, wherein the total number of risk and/or volatility products provided to the customer within a specified period of time does not exceed a specified limit.

19. A computer-readable medium as recited in claim 18, further comprising in response to a specified fee being received, the specified time limit is increased for another specified limit.

20. A computer-readable medium as recited in claim 17, wherein
the one or more risk and/or volatility product selection criteria indicates a desired order for the one or more risk and/or volatility products that a customer desires to rent,
the step of providing to the customer up to a determined number of the one or more of customizable risk and/or volatility products indicated by the one or risk and/or volatility product selection criteria includes providing to the customer up to a one or more of customized risk and/or volatility products indicated by the one or risk and/or volatility product selection criteria in the desired order indicated by the risk and/or volatility product selection criteria, and
the step of providing to the customer one or more of customized risk and/or volatility products indicated by the one or risk and/or volatility product selection criteria includes providing to the customer one or more of customized risk and/or volatility products indicated by one or risk and/or volatility product selection criteria in the desired order indicated by the one or risk and/or volatility product selection criteria.

21. A computer-readable medium as recited in claim 20, further comprising one or more sequences of one or more instructions which, when executed by the one or more processors, cause the one or more processors to perform the step of if a particular risk and/or volatility product from the one or more risk and/or volatility products indicated by the one or more risk and/or volatility product selection criteria is not available, then providing another risk and/or volatility product from the one or more risk and/or volatility products based upon the desired order indicated by the one or more risk and/or volatility product selection criteria.

22. A computer-readable medium as recited in claim 20, wherein providing a one or more risk and/or volatility product selection criteria corresponding to risk and/or volatility product attributes comprises conforming said options to production capabilities of the one or more producers.

23. A computer-readable medium as recited in claim 17, wherein
the applying the one or risk and/or volatility product selection criteria to a one or more producers indicates a customized risk and/or volatility product for the one or more risk and/or volatility products that one or more producers produce.
the step of manufacturing a one or more risk and/or volatility products by applying the one or risk and/or volatility product selection criteria to one or more producers includes receiving to the one or more producers up to the one or risk and/or volatility product selection criteria indicated by the one or risk and/or volatility product selection criteria in the desired order indicated by the risk and/or volatility product selection criteria, and
the step of manufacturing a one or more risk and/or volatility products by applying the one or risk and/or volatility product selection criteria to one or more producers includes automatic manufacturing by the one or more producers the one or more risk and/or volatility products that have the one or more preferred risk and/or volatility product attributes specified by the one or more risk and/or volatility product selection criteria.

24. A computer-readable medium as recited in claim 8, wherein applying the one or risk and/or volatility product selection criteria to one or more producers comprises manufacturing a specified number of risk and/or volatility products indicated by the customer's order.

25. The computer-readable medium in claim 1 further comprising receiving said selected option from the consumer to the one or more producers.

26. The computer-readable medium in claim 10 wherein said manufacturing a selected option into at least one machine instruction comprises manufacturing said selected option into at least one machine instruction at the producer.

27. A computer-readable medium as recited in claim 17,
further comprising:
establishing, based upon the risk and/or volatility product selection criteria, a risk and/or volatility product rental queue for the customer, wherein the risk and/or volatility product rental queue contains one or more entries that specify the one or more of customized risk and/or volatility products that the customer desires to rent.

28. A computer-readable medium as recited in claim 17,
further comprising in response to a specified fee being received, providing to the customer a time extension for using the one or more of customized risk and/or volatility products indicated by the one or risk and/or volatility product selection criteria.

29. A computer-readable medium as recited in claim 17,
further comprising in response to an expiration of a predetermined time limit, suspending in response to a signal the set of one or more of customized risk and/or volatility products indicated by the one or risk and/or volatility product selection criteria.

30. A computer-readable medium as recited in claim 17, wherein risk and/or volatility products are provided to the customer over the Internet.

31. A computer-readable medium as recited in claim 17,
wherein:
the one or more risk and/or volatility products are one or more element selected from a group comprising of means for measuring, monitoring, and/or displaying “liquidity risk,” means for measuring, monitoring, and/or displaying “settlement risk,” means for measuring, monitoring, and/or displaying “operational risk,” means for measuring, monitoring, and/or displaying “credit risk,” and means for measuring, monitoring, and/or displaying “systematic risk,” means for measuring, monitoring, and/or displaying “historical volatility,” and/or means for measuring, monitoring, and/or displaying “implied volatility,” and/or means for measuring, monitoring, and/or displaying “FX” and means for measuring, monitoring, and/or displaying “FX options,” and means for measuring, monitoring, and/or displaying “Margin trading,” and means for measuring, monitoring, and/or displaying “Fixed Income,” and means for measuring, monitoring, and/or displaying “Interest rate derivatives,” and means for measuring, monitoring, and/or displaying “Energy derivatives,” and means for measuring, monitoring, and/or displaying “Commodity and Metals trading and derivatives and Equity trading,”
the one or more risk and/or volatility product selection criteria are one or more of the group selection criteria,
the step of receiving a one or risk and/or volatility product selection criteria that indicates one or more risk and/or volatility products that a customer desires to rent;
the step of providing to the customer the one or risk and/or volatility product selection criteria indicated by the one or more risk and/or volatility product selection criteria;
the step of manufacturing a one or more risk and/or volatility products by applying the one or risk and/or volatility product selection criteria to a one or more producers;
the step of in response to receiving any of the one or risk and/or volatility product selection criteria that indicates one or more risk and/or volatility products, providing to the customer the one or risk and/or volatility product selection criteria indicated by the one or risk and/or volatility product selection criteria, manufacturing a one or more risk and/or volatility products by applying the one or risk and/or volatility product selection criteria to the one or more producers, delivering the one or more risk and/or volatility products by the one or more producers over a delivery channel, wherein a total current one or more risk and/or volatility products provided to the customer does not exceed a specified time limit.

32. An apparatus for renting, manufacturing, and delivering risk and/or volatility products to customers comprising:
one or more processors; and
a memory communicatively coupled to the one or more processors, the memory including one or more sequences of one or more instructions which, when executed by the one or more processors, cause the one or more processors to perform the steps of:
receiving a one or risk and/or volatility product selection criteria that indicates one or more risk and/or volatility products that a customer desires to rent;
providing to the customer the one or risk and/or volatility product selection criteria indicated by the one or more risk and/or volatility product selection criteria;
manufacturing a one or more risk and/or volatility products by applying the one or risk and/or volatility product selection criteria to a one or more producers;
delivering the one or more risk and/or volatility products by the one or more producers over a delivery channel;
in response to receiving any of the one or risk and/or volatility product selection criteria that indicates one or more risk and/or volatility products, providing to the customer the one or risk and/or volatility product selection criteria indicated by the one or risk and/or volatility product selection criteria, manufacturing a one or more risk and/or volatility products by applying the one or risk and/or volatility product selection criteria to the one or more producers, delivering the one or more risk and/or volatility products by the one or more producers over a delivery channel, wherein a total current one or more risk and/or volatility products provided to the customer does not exceed a specified time limit.

32. An apparatus as recited in claim 32, wherein the one or more risk and/or volatility products provided to the customer can only be used for a specified time limit.

32. An apparatus as recited in claim 32, further comprising in response to a specified fee being received, the specified time limit is increased for another specified limit.

33. An apparatus as recited in claim 32, wherein the memory further includes one or more sequences of one or more instructions which, when executed by the one or more processors, cause the one or more processors to perform the step of if the total number of risk and/or volatility products provided to the customer within the specified period of time is less than the specified limit, then increasing the specified limit for another specified period of time.

34. An apparatus as recited in claim 31, wherein
the one or more risk and/or volatility product selection criteria indicates a desired order for the one or more risk and/or volatility products that a customer desires to rent,
the step of providing to the customer up to a determined number of the one or more of customizable risk and/or volatility products indicated by the one or risk and/or volatility product selection criteria includes providing to the customer up to a one or more of customized risk and/or volatility products indicated by the one or risk and/or volatility product selection criteria in the desired order indicated by the risk and/or volatility product selection criteria, and
the step of providing to the customer one or more of customized risk and/or volatility products indicated by the one or risk and/or volatility product selection criteria includes providing to the customer one or more of customized risk and/or volatility products indicated by one or risk and/or volatility product selection criteria in the desired order indicated by the one or risk and/or volatility product selection criteria.

35. An apparatus as recited in claim 31, wherein providing a one or more risk and/or volatility product selection criteria corresponding to risk and/or volatility product attributes comprises conforming said options to production capabilities of the one or more producers.

36. An apparatus as recited in claim 35, wherein the memory further includes one or more sequences of one or more instructions which, when executed by the one or more processors, cause the one or more processors to perform the step of if a particular risk and/or volatility product from the one or more risk and/or volatility products indicated by the one or more risk and/or volatility product selection criteria is not available, then providing another risk and/or volatility product from the one or more risk and/or volatility products based upon the desired order indicated by the one or more risk and/or volatility product selection criteria.

37. An apparatus as recited in claim 31, wherein
the applying the one or risk and/or volatility product selection criteria to a one or more producers indicates a customized risk and/or volatility product for the one or more risk and/or volatility products that one or more producers produce.
the step of manufacturing a one or more risk and/or volatility products by applying the one or risk and/or volatility product selection criteria to one or more producers includes receiving to the one or more producers up to the one or risk and/or volatility product selection criteria indicated by the one or risk and/or volatility product selection criteria in the desired order indicated by the risk and/or volatility product selection criteria, and
the step of manufacturing a one or more risk and/or volatility products by applying the one or risk and/or volatility product selection criteria to one or more producers includes automatic manufacturing by the one or more producers the one or more risk and/or volatility products that have the one or more preferred risk and/or volatility product attributes specified by the one or more risk and/or volatility product selection criteria.

38. An apparatus as recited in claim 51, wherein applying the one or risk and/or volatility product selection criteria to one or more producers comprises manufacturing a specified number of risk and/or volatility products indicated by the customer's order.

39. An apparatus as recited in claim 31 further comprising receiving said selected option from the consumer to the one or more producers.

40. An apparatus as recited in claim 31 wherein said manufacturing a selected option into at least one machine instruction comprises manufacturing said selected option into at least one machine instruction at the producer.

41. An apparatus as recited in claim 31,
further comprising:
establishing, based upon the risk and/or volatility product selection criteria, a risk and/or volatility product rental queue for the customer, wherein the risk and/or volatility product rental queue contains one or more entries that specify the one or more of customized risk and/or volatility products that the customer desires to rent.

42. An apparatus as recited in claim 31,
further comprising in response to a specified fee being received, providing to the customer a time extension for using the one or more of customized risk and/or volatility products indicated by the one or risk and/or volatility product selection criteria.

43. An apparatus as recited in claim 31,
further comprising in response to a expiration of the predetermined time limit, suspending in response to a signal the set of one or more of customized risk and/or volatility products indicated by the one or risk and/or volatility product selection criteria.

44. An apparatus as recited in claim 31, wherein risk and/or volatility products are provided to the customer over the Internet.

45. An apparatus as recited in claim 31, wherein:
the one or more risk and/or volatility products are one or more element selected from a group comprising of means for measuring, monitoring, and/or displaying “liquidity risk,” means for measuring, monitoring, and/or displaying “settlement risk,” means for measuring, monitoring, and/or displaying “operational risk,” means for measuring, monitoring, and/or displaying “credit risk,” and means for measuring, monitoring, and/or displaying “systematic risk,” means for measuring, monitoring, and/or displaying “historical volatility,” and/or means for measuring, monitoring, and/or displaying “implied volatility,” and/or means for measuring, monitoring, and/or displaying “FX” and means for measuring, monitoring, and/or displaying “FX options,” and means for measuring, monitoring, and/or displaying “Margin trading,” and means for measuring, monitoring, and/or displaying “Fixed Income,” and means for measuring, monitoring, and/or displaying “Interest rate derivatives,” and means for measuring, monitoring, and/or displaying “Energy derivatives,” and means for measuring, monitoring, and/or displaying “Commodity and Metals trading and derivatives and Equity trading.”
the one or more risk and/or volatility product selection criteria are one or more of the group selection criteria,
the step of receiving a one or risk and/or volatility product selection criteria that indicates one or more risk and/or volatility products that a customer desires to rent;
the step of providing to the customer the one or risk and/or volatility product selection criteria indicated by the one or more risk and/or volatility product selection criteria;
the step of intermediating to the customer the one or risk and/or volatility product selection criteria indicated by the one or more risk and/or volatility product selection criteria;
the step of manufacturing a one or more risk and/or volatility products by applying the one or risk and/or volatility product selection criteria to a one or more producers;
the step of in response to receiving any of the one or risk and/or volatility product selection criteria that indicates one or more risk and/or volatility products, providing to the customer the one or risk and/or volatility product selection criteria indicated by the one or risk and/or volatility product selection criteria, manufacturing a one or more risk and/or volatility products by applying the one or risk and/or volatility product selection criteria to the one or more producers, delivering the one or more risk and/or volatility products by the one or more producers over a delivery channel, wherein a total current one or more risk and/or volatility products provided to the customer does not exceed a specified time limit.

46. An apparatus for renting, manufacturing, and delivering risk and/or volatility products to customers comprising a risk and/or volatility product rental mechanism configured to:
receive a one or risk and/or volatility product selection criteria that indicates one or more risk and/or volatility products that a customer desires to rent;
provide to the customer the one or risk and/or volatility product selection criteria indicated by the one or more risk and/or volatility product selection criteria;
manufacture a one or more risk and/or volatility products by applying the one or risk and/or volatility product selection criteria to a one or more producers;
intermediating the one or more risk and/or volatility products by the one or more producers over a delivery channel;
deliver the one or more risk and/or volatility products by the one or more producers over a delivery channel;
in response to receiving any of the one or risk and/or volatility product selection criteria that indicates one or more risk and/or volatility products, providing to the customer the one or risk and/or volatility product selection criteria indicated by the one or risk and/or volatility product selection criteria, manufacturing a one or more risk and/or volatility products by applying the one or risk and/or volatility product selection criteria to the one or more producers, delivering the one or more risk and/or volatility products by the one or more producers over a delivery channel, wherein a total current one or more risk and/or volatility products provided to the customer does not exceed a specified time limit.

47. An apparatus as recited in claim 46, wherein the one or more risk and/or volatility products provided to the customer can only be used for a specified time limit.

48. An apparatus as recited in claim 47, further comprising in response to a specified fee being received, the specified time limit is increased for another specified limit.

49. An apparatus as recited in claim 46, wherein
the one or more risk and/or volatility product selection criteria indicates a desired order for the one or more risk and/or volatility products that a customer desires to rent,
the step of providing to the customer up to a determined number of the one or more of customizable volatility products indicated by the one or more of risk and/or volatility product selection criteria includes providing to the customer up to a one or more of customized risk and/or volatility products indicated by the one or more of risk and/or volatility product selection criteria in the desired order indicated by the volatility product selection criteria, and
the step of providing to the customer one or more of customized risk and/or volatility products indicated by the one or more of risk and/or volatility product selection criteria includes providing to the customer one or more of customized risk and/or volatility products indicated by one or more of risk and/or volatility product selection criteria in the desired order indicated by the one or more of risk and/or volatility product selection criteria.

51. An apparatus as recited in claim 46, wherein applying the one or more of risk and/or volatility product selection criteria to one or more producers comprises manufacturing a specified number of volatility products indicated by the customer's order.

52. An apparatus as recited in claim 46 further comprising receiving said selected option from the consumer to the one or more producers.

53. An apparatus as recited in claim 46 wherein said manufacturing a selected option into at least one machine instruction comprises manufacturing said selected option into at least one machine instruction at the producer.

54. An apparatus as recited in claim 46, wherein
the applying the one or risk and/or volatility product selection criteria to a one or more producers indicates a customized risk and/or volatility product for the one or more risk and/or volatility products that one or more producers produce.
the step of manufacturing a one or more risk and/or volatility products by applying the one or risk and/or volatility product selection criteria to one or more producers includes receiving to the one or more producers up to the one or risk and/or volatility product selection criteria indicated by the one or risk and/or volatility product selection criteria in the desired order indicated by the risk and/or volatility product selection criteria, and
the step of manufacturing a one or more risk and/or volatility products by applying the one or risk and/or volatility product selection criteria to one or more producers includes automatic manufacturing by the one or more producers the one or more risk and/or volatility products that have the one or more preferred risk and/or volatility product attributes specified by the one or more risk and/or volatility product selection criteria.

55. An apparatus as recited in claim 46,
further comprising:
establishing, based upon the risk and/or volatility product selection criteria, a risk and/or volatility product rental queue for the customer, wherein the risk and/or volatility product rental queue contains one or more entries that specify the one or more of customized risk and/or volatility products that the customer desires to rent.

56. An apparatus as recited in claim 46,
further comprising in response to a specified fee being received, providing to the customer a time extension for using the one or more of customized risk and/or volatility products indicated by the one or risk and/or volatility product selection criteria.

57. An apparatus as recited in claim 46,
further comprising in response to an expiration of a predetermined time limit, suspending in response to a signal the set of one or more of customized risk and/or volatility products indicated by the one or risk and/or volatility product selection criteria.

58. An apparatus as recited in claim 46, wherein risk and/or volatility products are provided to the customer over the Internet.

59. An apparatus as recited in claim 46, wherein:
the one or more risk and/or volatility products are one or more element selected from a group comprising of means for measuring, monitoring, and/or displaying “liquidity risk,” means for measuring, monitoring, and/or displaying “settlement risk,” means for measuring, monitoring, and/or displaying “operational risk,” means for measuring, monitoring, and/or displaying “credit risk,” and means for measuring, monitoring, and/or displaying “systematic risk,” means for measuring, monitoring, and/or displaying “historical volatility,” and/or means for measuring, monitoring, and/or displaying “implied volatility,” and/or means for measuring, monitoring, and/or displaying “FX” and means for measuring, monitoring, and/or displaying “FX options,” and means for measuring, monitoring, and/or displaying “Margin trading,” and means for measuring, monitoring, and/or displaying “Fixed Income,” and means for measuring, monitoring, and/or displaying “Interest rate derivatives,” and means for measuring, monitoring, and/or displaying “Energy derivatives,” and means for measuring, monitoring, and/or displaying “Commodity and Metals trading and derivatives and Equity trading,”
the one or more risk and/or volatility product selection criteria are one or more of the group selection criteria,
the step of receiving a one or risk and/or volatility product selection criteria that indicates one or more risk and/or volatility products that a customer desires to rent;
the step of providing to the customer the one or risk and/or volatility product selection criteria indicated by the one or more risk and/or volatility product selection criteria;
the step of manufacturing a one or more risk and/or volatility products by applying the one or risk and/or volatility product selection criteria to a one or more producers;
the step of intermediating a one or more risk and/or volatility products by applying the one or risk and/or volatility product selection criteria to a one or more producers;
the step of in response to receiving any of the one or risk and/or volatility product selection criteria that indicates one or more risk and/or volatility products, providing to the customer the one or risk and/or volatility product selection criteria indicated by the one or risk and/or volatility product selection criteria, manufacturing a one or more risk and/or volatility products by applying the one or risk and/or volatility product selection criteria to the one or more producers, delivering the one or more risk and/or volatility products by the one or more producers over a delivery channel, wherein a total current one or more risk and/or volatility products provided to the customer does not exceed a specified time limit.

60. A computer-readable medium for renting, manufacturing, and delivering risk and/or volatility products to customers, the computer-readable medium carrying one or more sequences of one or more instructions which, when executed by one or more processors, cause the one or more processors to perform the computer-implemented steps of:
receiving a one or more of risk and/or volatility product selection criteria that indicates one or more risk and/or volatility products that a customer desires to rent;
providing to the customer the one or more of risk and/or volatility product selection criteria indicated by the one or more risk and/or volatility product selection criteria;
manufacturing a one or more risk and/or volatility products by applying the one or more of risk and/or volatility product selection criteria to a one or more producers;
intermediating a one or more risk and/or volatility products by applying the one or more of risk and/or volatility product selection criteria to a one or more producers;
delivering the one or more risk and/or volatility products by the one or more producers over a delivery channel;
in response to receiving any of the one or more of risk and/or volatility product selection criteria that indicates one or more risk and/or volatility products, providing to the customer the one or more of risk and/or volatility product selection criteria indicated by the one or more of risk and/or volatility product selection criteria, manufacturing a one or more risk and/or volatility products by applying the one or more of risk and/or volatility product selection criteria to the one or more producers, delivering the one or more risk and/or volatility products by the one or more producers over a delivery channel, wherein a total current one or more risk and/or volatility products provided to the customer does not exceed a specified time limit.

61. A computer-readable medium as recited in claim 60, wherein the one or more risk and/or volatility products provided to the customer can only be used for a specified time limit.

62. A computer-readable medium as recited in claim 60, further comprising in response to a specified fee being received, the specified time limit is increased for another specified limit.

63. A computer-readable medium as recited in claim 60, wherein
the one or more risk and/or volatility product selection criteria indicates a desired order for the one or more risk and/or volatility products that a customer desires to rent,
the step of providing to the customer up to a determined number of the one or more of customizable volatility products indicated by the one or more of risk and/or volatility product selection criteria includes providing to the customer up to a one or more of customized risk and/or volatility products indicated by the one or more of risk and/or volatility product selection criteria in the desired order indicated by the volatility product selection criteria, and
the step of providing to the customer one or more of customized risk and/or volatility products indicated by the one or more of risk and/or volatility product selection criteria includes providing to the customer one or more of customized risk and/or volatility products indicated by one or more of risk and/or volatility product selection criteria in the desired order indicated by the one or more of risk and/or volatility product selection criteria.

64. A computer-readable medium as recited in claim 63, wherein providing a one or more risk and/or volatility product selection criteria corresponding to volatility product attributes comprises conforming said options to production capabilities of the one or more producers.

65. A computer-readable medium as recited in claim 60, wherein
the applying the one or risk and/or volatility product selection criteria to a one or more producers indicates a customized risk and/or volatility product for the one or more risk and/or volatility products that one or more producers produce.
the step of manufacturing a one or more risk and/or volatility products by applying the one or risk and/or volatility product selection criteria to one or more producers includes receiving to the one or more producers up to the one or risk and/or volatility product selection criteria indicated by the one or risk and/or volatility product selection criteria in the desired order indicated by the risk and/or volatility product selection criteria, and
the step of manufacturing a one or more risk and/or volatility products by applying the one or risk and/or volatility product selection criteria to one or more producers includes automatic manufacturing by the one or more producers the one or more risk and/or volatility products that have the one or more preferred risk and/or volatility product attributes specified by the one or more risk and/or volatility product selection criteria.

65. A computer-readable medium as recited in claim 60, wherein
the applying the one or risk and/or volatility product selection criteria to a one or more producers indicates a customized risk and/or volatility product for the one or more risk and/or volatility products that one or more producers produce,
the step of intermediating a one or more risk and/or volatility products by applying the one or risk and/or volatility product selection criteria to one or more producers includes receiving to the one or more producers up to the one or risk and/or volatility product selection criteria indicated by the one or risk and/or volatility product selection criteria in the desired order indicated by the risk and/or volatility product selection criteria, and
the step of intermediating a one or more risk and/or volatility products by applying the one or risk and/or volatility product selection criteria to one or more producers includes automatic manufacturing by the one or more producers the one or more risk and/or volatility products that have the one or more preferred risk and/or volatility product attributes specified by the one or more risk and/or volatility product selection criteria.

66. A computer-readable medium as recited in claim 60, wherein applying the one or more of risk and/or volatility product selection criteria to one or more producers comprises manufacturing a specified number of volatility products indicated by the customer's order.

67. The computer-readable medium in claim 68 further comprising receiving said selected option from the consumer to the one or more producers.

68. The computer-readable medium in claim 67 wherein said manufacturing a selected option into at least one machine instruction comprises manufacturing said selected option into at least one machine instruction at the producer.

69. A computer-readable medium as recited in claim 60,
further comprising:
establishing, based upon the volatility product selection criteria, a volatility product rental queue for the customer, wherein the volatility product rental queue contains one or more entries that specify the one or more of customized risk and/or volatility products that the customer desires to rent.

70. A computer-readable medium as recited in claim 60,
further comprising in response to a specified fee being received, providing to the customer a time extension for using the one or more of customized risk and/or volatility products indicated by the one or more of risk and/or volatility product selection criteria.

71. A computer-readable medium as recited in claim 60,
further comprising in response to a expiration of the predetermined time limit, suspending in response to a signal the set of one or more of customized risk and/or volatility products indicated by the one or risk and/or volatility product selection criteria.

72. A computer-readable medium as recited in claim 60, wherein risk and/or volatility products are provided to the customer over the Internet.

73. A computer-readable medium as recited in claim 60,
wherein:
the one or more risk and/or volatility products are one or more element selected from a group comprising of means for measuring historical volatility and means for measuring implied volatility,
the one or more risk and/or volatility product selection criteria are one or more of the group selection criteria,
the step of receiving a one or more of risk and/or volatility product selection criteria that indicates one or more risk and/or volatility products that a customer desires to rent;
the step of providing to the customer the one or more of risk and/or volatility product selection criteria indicated by the one or more risk and/or volatility product selection criteria;
the step of manufacturing a one or more risk and/or volatility products by applying the one or more of risk and/or volatility product selection criteria to a one or more producers;
the step of intermediating a one or more risk and/or volatility products by applying the one or more of risk and/or volatility product selection criteria to a one or more producers;
the step of in response to receiving any of the one or more of risk and/or volatility product selection criteria that indicates one or more risk and/or volatility products, providing to the customer the one or more of risk and/or volatility product selection criteria indicated by the one or more of risk and/or volatility product selection criteria, manufacturing a one or more risk and/or volatility products by applying the one or more of risk and/or volatility product selection criteria to the one or more producers, intermediating a one or more risk and/or volatility products by applying the one or more of risk and/or volatility product selection criteria to the one or more producers, delivering the one or more risk and/or volatility products by the one or more producers over a delivery channel, wherein a total current one or more risk and/or volatility products provided to the customer does not exceed a specified time limit.

74. A computer-readable medium for renting, manufacturing, and delivering risk and/or volatility products to customers, the computer-readable medium carrying one or more sequences of one or more instructions which, when executed by one or more processors, cause the one or more processors to perform the computer-implemented steps of:
receiving a one or more of risk and/or volatility product selection criteria that indicates one or more risk and/or volatility products that a customer desires to rent;
providing to the customer the one or more of risk and/or volatility product selection criteria indicated by the one or more risk and/or volatility product selection criteria;
manufacturing a one or more risk and/or volatility products by applying the one or more of risk and/or volatility product selection criteria to a one or more producers;
intermediating the one or more risk and/or volatility products by the one or more producers over a delivery channel;
delivering the one or more risk and/or volatility products by the one or more producers over a delivery channel;
in response to receiving any of the one or more of risk and/or volatility product selection criteria that indicates one or more risk and/or volatility products, providing to the customer the one or more of risk and/or volatility product selection criteria indicated by the one or more of risk and/or volatility product selection criteria, manufacturing a one or more risk and/or volatility products by applying the one or more of risk and/or volatility product selection criteria to the one or more producers, delivering the one or more risk and/or volatility products by the one or more producers over a delivery channel, wherein a total current one or more risk and/or volatility products provided to the customer does not exceed a specified time limit.

75. A computer-readable medium as recited in claim 74, wherein the one or more risk and/or volatility products provided to the customer can only be used for a specified time limit.

76. A computer-readable medium as recited in claim 74, further comprising in response to a specified fee being received, the specified time limit is increased for another specified limit.

77. A computer-readable medium as recited in claim 74, wherein
the one or more risk and/or volatility product selection criteria indicates a desired order for the one or more risk and/or volatility products that a customer desires to rent,
the step of providing to the customer up to a determined number of the one or more of customizable volatility products indicated by the one or more of risk and/or volatility product selection criteria includes providing to the customer up to a one or more of customized risk and/or volatility products indicated by the one or more of risk and/or volatility product selection criteria in the desired order indicated by the volatility product selection criteria, and
the step of providing to the customer one or more of customized risk and/or volatility products indicated by the one or more of risk and/or volatility product selection criteria includes providing to the customer one or more of customized risk and/or volatility products indicated by one or more of risk and/or volatility product selection criteria in the desired order indicated by the one or more of risk and/or volatility product selection criteria.

78. A computer-readable medium as recited in claim 74, wherein
the applying the one or risk and/or volatility product selection criteria to a one or more producers indicates a customized risk and/or volatility product for the one or more risk and/or volatility products that one or more producers produce.
the step of manufacturing a one or more risk and/or volatility products by applying the one or risk and/or volatility product selection criteria to one or more producers includes receiving to the one or more producers up to the one or risk and/or volatility product selection criteria indicated by the one or risk and/or volatility product selection criteria in the desired order indicated by the risk and/or volatility product selection criteria, and
the step of manufacturing a one or more risk and/or volatility products by applying the one or risk and/or volatility product selection criteria to one or more producers includes automatic manufacturing by the one or more producers the one or more risk and/or volatility products that have the one or more preferred risk and/or volatility product attributes specified by the one or more risk and/or volatility product selection criteria.

79. A computer-readable medium as recited in claim 74, wherein risk and/or volatility products are provided to the customer over the Internet.
